(19) United States
(12) Patent Application Publication
(10) Pub. No.: US 2010/0235206 A1
(43) Pub. Date: Sep. 16, 2010

(54) Methods and Systems for Modular Buildings

(75) Inventors: Mark R. Miller, San Francisco, CA (US); Adam Tibbs, San Francisco, CA (US); George Loisos, Oakland, CA (US); M. Susan Ubbelohde, Oakland, CA (US); David Scheer, El Cerrito, CA (US)

Correspondence Address: THE WEBB LAW FIRM, P.C., 700 KOPPERS BUILDING, 436 SEVENTH AVENUE, PITTSBURGH, PA, 15219, US

(73) Assignee: PROJECT FROG, INC., San Francisco, CA (US)

(21) Appl. No.: 12/618,196

(22) Filed: Nov. 13, 2009

Related U.S. Application Data
(63) Continuation-in-part of application No. 12/617,713, filed on Nov. 12, 2009.
(60) Provisional application No. 61/114,726, filed on Nov. 14, 2008.
(60) Provisional application No. 61/114,626, filed on Nov. 14, 2008.

(51) Int. Cl. G06F 17/50; E04H 6/00; G06Q 10/00; E04H 14/00

(52) U.S. Cl. 705/7; 52/79.1; 703/1; 52/1

(57) ABSTRACT

The present invention provides a multifunctional building panel which may comprise a sensor to measure an interior condition and an exterior condition and generate a signal in response, along with systems and methods for designing, optimizing and constructing modular buildings, including buildings constructed at least in part of multifunctional building panels, by utilizing a priority distribution ranking as an optimization constraint.

### CROSS-REFERENCE TO RELATED APPLICATIONS

This application claims the benefit of the following United States Provisional applications, each of which are hereby incorporated by reference in their entirety:

Application Ser. No. 61/114,726 filed Nov. 14, 2008, and Application Ser. No. 61/114,626 filed Nov. 14, 2008.

This application is also a continuation-in-part of U.S. Nonprovisional patent application Ser. No. 12/617,713 entitled “Smart Multifunctioning Building Panel” filed Nov. 12, 2009, the disclosure of which is hereby incorporated herein by reference in its entirety.

### BACKGROUND OF THE INVENTION

1. Field of the Invention

The invention relates to the field of modular buildings, and more specifically to smart or multifunctional panels and methods, systems and computer program products for designing, optimizing and constructing modular buildings.

2. Description of the Related Art

Modern buildings and building components that are intelligent and take the environment into consideration reduce the energy usage and carbon footprint of the building. With the increasing problems of climate change and environmental degradation, as well as a renewed focus placed on reduced cost and shorter construction times, it is becoming more and more important for the building industry to become cost-optimized, energy efficient and “green.” There is also an increasing need for buildings which have reduced environmental impacts in terms of energy usage, emissions, green construction materials and components, on-site construction, and the ultimate end-of-life reuse and/or recycling potential. Energy efficient buildings also reduce the energy required to operate a building, which reduces costs without compromising the comfort levels of its occupants.

The exterior environment and layout of a building can also a significantly impact the energy consumed by the building. For example, in hot or summer environments, it may be desirable to allow hot air that accumulates within the building to escape from the interior of the building. Releasing heated air reduces the amount of energy required to cool the interior of the building. In contrast, in cold or winter environments, it may be desirable to prevent leakage of hot air from the building and thereby increase its energy efficiency. Controlling building functions based on the temperatures or other attributes of the sunny or shade side of the building can also affect energy consumption within the building. For example, the sunny side of a building can be at temperatures which are 2° to 8° C. higher than the shade side of the same building. When building air intake vents are located on the sunny side, in summer, air retrieved from that side of the building has to be cooled by an additional amount to reach the desired cool interior temperatures. Conversely, in winter, air retrieved from the shady side of the building has to be heated by an additional amount to reach the desired heated temperatures. An intelligent building that takes these factors into consideration in operating the building would save energy.

Still further, in some situations, it is also desirable to have buildings that can partially or entirely generate their own energy requirements. For example, in certain remote sites or at new construction sites, access to a main utility or power grid may not be available. In these sites, the construction or operation of conventional buildings requires the setup of large generators to power lights, heat, and communications equipment in the building, or construction tools used to assemble the building. However, such generators tend to be noisy and polluting, and require continuous supplies of combustible fuels in order to operate. The generators are also heavy to transport and their size and weight are proportional to their maximum load outputs. Even when a main grid power connection is available, an energy generating building can reduce its use of carbon fuels and lower operating costs. Thus, energy-producing building components are desirable to address these needs.

Yet another application of smart or intelligent building components occurs in the fabrication of modular buildings or buildings assembled on-site from predesigned building kits. Modular and kit buildings can be made from pre-fabricated structural members or panels that are designed and developed to facilitate shipment, assembly, and operation of a building. Predesigned components for modular or kit buildings reduce the fabrication and assembly costs for building structures that have a common purpose. Thus, building components such as panels and other structural members that facilitate shipping, assembly of the building, and design of the building can be useful.

For reasons including these and other deficiencies, and despite the development of many different building components, such as panels and other structural members, further improvements in such components are continuously being sought, and methods, systems and computer program products for designing, optimizing and constructing modular buildings are needed, to improve the quality, efficiency, ease and speed of construction and operation of modern buildings.

### SUMMARY OF THE INVENTION

The invention relates to a smart or multifunctional panel for a modular building and methods, systems and computer program products for designing, optimizing and constructing modular buildings. In one embodiment, a multifunctional panel for a building comprises an insulative body, an exterior surface that is weather resistant, and an interior surface that opposes the weather resistant exterior surface. One or more sensors provided to measure an interior condition in the interior of the building and an exterior condition in the exterior of the building, and generate a sensor signal in response to the difference between the measured interior and exterior conditions. A signal coupler to transmit the sensor signal to other multifunctional panels, receive an input signal from another multifunctional panel, or pass power to power a device in or about the insulative body.

In another embodiment, a multifunctional panel comprises an insulative body comprising an energy storage device having a pair of terminals and opposing interior and exterior surfaces, the exterior surface including a photovoltaic array comprising a plurality of photovoltaic cells connected to one another and a pair of output terminals that are electrically coupled to the terminals of the battery.

In yet another embodiment, a multifunctional panel comprises an exterior surface that is weather resistant, an interior surface that opposes the exterior surface, and an insulative body between the interior and exterior surfaces. A first sensor is provided to measure an interior condition in the interior of the building and generate an interior-condition signal, and a second sensor to measure an exterior condition in the exterior of the building and generate an exterior-condition signal. A switch is used to a turn a device on or off in response to the interior-condition signal, exterior-condition signal, or both.

Another embodiment of the invention relates to a kit of multifunctional panels for a building, the kit comprising a sensor panel comprising: (i) an exterior surface, an interior surface, and an insulative body between the interior and exterior surfaces; (ii) a sensor to measure an interior condition of the building or an exterior condition of the building and generate a sensor signal; and (iii) a signal coupler to transmit the sensor signal to other panels, receive an input signal from another panel, or pass power to power a device in or about the insulative body. The kit also includes a controller panel comprising an exterior surface, an interior surface, and an insulative body between the interior and exterior surfaces, and a controller to receive a signal from the signal coupler to control a device in or about the insulative body.

In an embodiment, a modular building may comprise a shed comprising a framework of spaced apart columns that are linked to one another by overhead roof trusses, and a clerestory roof comprising a plurality of roof panels, wherein at least some of the roof panels are transparent to light. A multifunctional panel may be on the shed or roof of the modular building.

Another embodiment of the invention relates to a modular building platform that may include and/or interface or communicate with various functionalities, features, facilities, engines and the like, including, but not limited to a customer interface, a configuration facility, a simulation facility, an optimization facility, a CAD facility, a vendor facility, internal systems, external systems, a shared calendar, outputs, such as performance predictions, architecture drawings, installation drawings, a bill of materials, permits, costing, quotes, schedules and the like, customizations, an install base, which may contain sensors, monitoring software and the like, and the like.

In embodiments, methods, systems and computer program products for determining a priority ranking distribution of two or more parameters may be provided. The priority ranking distribution for optimization of two or more parameters may specify a desired parameter value and an importance ranking for each parameter. A configuration facility may generate a proposed modular building design, which may be analyzed by a simulation facility with respect to one or more selected variables. The proposed modular building design may be optimized at an optimization facility using the limitations set by the priority ranking distribution to generate a design for construction of the modular building.

In embodiments, a subset of two or more parameters to be considered in the optimization may be selected from the group consisting of quality, environmental performance, speed of delivery and cost, and the like. In embodiments, one of the specified desired parameter values may be accompanied by a tolerance range, a variance distribution and the like. In embodiments, the proposed design of the modular building may satisfy certain requirements relating to the area, volume and aesthetics of the modular building. In embodiments, the proposed modular building may be composed of pre-fabricated, modular building components. In embodiments, the configuration facility may be programmed with rules governing the interaction of the modular building components. In embodiments, the selected variables may be selected from the group consisting of energy use, day lighting, thermal comfort and the like. In embodiments, the optimization facility may partially or completely utilize elimination parametrics. In embodiments, the outputs may be selected from the group consisting of architecture drawings, installation drawings, a bill of materials, permits, quotes and schedules, and the like.

In embodiments, methods, systems and computer program products for conducting three dimensional analyses may be provided. The three dimensional analysis may include comparing options associated with the three parameters and creating three two-dimensional graphs. The two dimensional graphs may provide pair-wise comparison of the three parameters. In addition, a first optimum option from each of the parameters may be selected from each of the two-dimensional graphs based on a metric. Each of the first optimum parameters obtained from the three dimensional analysis may be utilized in a multi-parametric interactive analysis to obtain a second optimum option for each of the parameters in the multi-parametric analysis.

In embodiments, the parameters may include at least three of orientation, wall insulation, roof insulation, thermal mass, roof overhangs, clerestory windows, storefront windows, other windows and ventilation area, and the like. In embodiments, the metric may include one or more of cost, comfort, energy efficiency and the like. In embodiments, the multi-parametric analysis may include options for greater than three parameters or at least nine parameters. In embodiments, the options considered for each parameter may be limited by an associated tolerance. In embodiments, a second optimum option for a parameter may be same as the first optimum option for the parameter.

In embodiments, methods, systems and computer program products for constructing a modular building by optimization using a priority ranking distribution of two or more parameters may be provided. The method may determine priority ranking distribution for two or more parameters to be considered in an optimization and may specify a desired parameter value and an importance ranking for each parameter. Further, a proposed design of a modular building that may satisfy certain requirements may be created. This design may be analyzed using one or more selected variables and optimized under the constraints of the priority ranking distribution. Subsequently, the proposed design may be modified by the outcome of optimization to create a modified proposed design. Finally, the modified proposed design may be validated, and outputs may be generated for the modified proposed design for construction of a modular building.

In embodiments, a subset of two or more parameters that may be considered in the optimization may be selected from the group consisting of quality, environmental performance, speed of delivery, cost and the like. In embodiments, one of the specified desired parameter values may be accompanied by a tolerance range, a variance distribution and the like. In embodiments, the proposed design of the modular building may satisfy certain requirements relating to the area, volume and aesthetics of the modular building. In embodiments, the proposed modular building may be composed of pre-fabricated, modular building components. In embodiments, the selected variables may be selected from the group consisting of energy use, daylighting, thermal comfort and the like. In embodiments, the optimization facility may partially or completely utilize elimination parametrics. In embodiments, the modifications to the proposed design may relate to a change in one or more building materials, length of window overhangs and amount of thermal mass. In embodiments, the validation may be a safety validation or may assess compliance with laws, rules and regulations. In embodiments, the outputs may be selected from the group consisting of architecture drawings, installation drawings, a bill of materials, permits, quotes, schedules and the like. In embodiments, the method may be implemented in part or completely in one or more processors capable of executing programmed instructions.

In embodiments, methods, systems and computer program products for optimizing the design of a modular building may be provided. The optimization of the design of a modular building may be performed in consideration of a priority ranking distribution of parameters. These parameters may be associated with the modular building. In addition, the priority ranking distribution may rank the parameters in terms of importance of two or more of the parameters to be considered in the optimization and may specify a desired parameter value for each parameter.

In embodiments, a subset of two or more parameters to be considered in the optimization may be selected from the group consisting of quality, environmental performance, speed of delivery, cost and the like. In embodiments, one or more of the specified desired parameter values may be accompanied by a tolerance range and a variance distribution.

### BRIEF DESCRIPTION OF THE DRAWINGS

The invention and the following detailed description of certain embodiments thereof may be understood by reference to the following figures:

FIG. 1A depicts a perspective exploded view of an embodiment of a multifunctional panel for a modular building;

FIG. 1B depicts a partial sectional side view of two multifunctional panels having side splines that are coupled together, and showing the male and female electrical couplers of the two panels that can be plugged into one another;

FIG. 1C depicts a detailed partial sectional side view of a portion C of the panel of FIG. 1B;

FIG. 1D depicts a schematic sectional side view of a panel showing a differential signal generator connected to the sensors and the signal couplers, and an internet device;

FIG. 2 depicts a perspective exploded partial sectional view of another embodiment of a multifunctional panel having a frame;

FIG. 3 depicts a perspective partial sectional view of an embodiment of a multifunctional panel comprising photovoltaic cells and batteries;

FIG. 4A-C depicts electrical block diagrams showing the circuit connections to transfer electrical power generated by the photovoltaic cells to a battery, grid or lights, respectively;

FIG. 5 depicts a perspective exploded view of a section of a frame of a modular building comprising a tilted roof having multifunction panels comprising photovoltaic cells;

FIG. 6 depicts a side perspective view of a frame of a modular building comprising a shed, and titled roof, over a concrete grade beam foundation;

FIG. 7 depicts a schematic perspective view of the frame of an embodiment of a modular building having a shed with a tilted roof that forms a clerestory and a side expansion module;

FIG. 8 depicts a perspective view of an embodiment of a modular building having a shed, clerestory, two opposing expansion modules, and multifunctional and sensor panels;

FIG. 9 depicts a modular building platform, in accordance with an embodiment of the present invention;

FIG. 10 depicts a customer interface, in accordance with an embodiment of the present invention;

FIG. 11 depicts a user interface for a customer interface, in accordance with an embodiment of the present invention;

FIG. 12 depicts a configuration facility user interface, in accordance with an embodiment of the present invention;

FIG. 13 depicts a user interface of a simulation facility, in accordance with an embodiment of the present invention;

FIG. 14 depicts a sample optimization process flow, in accordance with an embodiment of the present invention;

FIG. 15 depicts a plot of energy use on a 3-dimensional parametric graph, in accordance with an embodiment of the present invention;

FIG. 16 depicts a plot of overall cost-effectiveness charting the 3-dimensional parametric set, in accordance with an embodiment of the present invention;

FIG. 17 depicts the top 40 configurations for Honolulu plotted by cost effectiveness and energy demand, in accordance with an embodiment of the present invention;

FIG. 18 depicts a process flow for the optimization process, in accordance with an embodiment of the present invention;

FIG. 19 depicts an optimization facility user interface, in accordance with an embodiment of the present invention;

FIG. 20 depicts a vendor facility user interface, in accordance with an embodiment of the present invention;

FIG. 21 depicts an installation monitoring facility user interface, in accordance with an embodiment of the present invention;

FIG. 22 depicts an architect dashboard, in accordance with an embodiment of the present invention;

FIG. 23 depicts a contractor dashboard, in accordance with an embodiment of the present invention;

FIG. 24 depicts a vendor dashboard, in accordance with an embodiment of the present invention;

FIG. 25 depicts a specific alternate modular building platform, in accordance with an embodiment of the present invention; and

FIG. 26 depicts another specific alternate modular building platform, in accordance with an embodiment of the present invention.

FIG. 27 depicts a method of optimizing a modular building.

### DESCRIPTION OF THE PREFERRED EMBODIMENTS

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as connected, although not necessarily directly and not necessarily mechanically.

Embodiments of the present invention relate to a smart or multifunctional panel 20 for any building or building structure, such as a modular building, and which can be used to perform any one or more of a variety of functions to increase the energy efficiency of the building or to facilitate its operation or use, such as by collecting data. A modular building may be created in whole or in part of smart or multifunctional panels 20. A modular building may be created at least in part of pre-fabricated components. A smart or multifunctional panel 20 may be pre-fabricated. The pre-fabricated components may be created at a site and then shipped to another site where they are assembled to form, all or a part of, a modular building. A modular building may be portable and mobile. A modular building may include, without limitation, a house, shed, residential building, school, portable classroom, institutional building, retail building, office space, commercial building and the like. An example of a modular building is as described in United States Patent Application Publication No. 20080202048 entitled “RAPIDLY DEPLOYABLE MODULAR BUILDING AND METHODS” the disclosure of which is hereby incorporated herein by reference in its entirety. In embodiments, the modular building may be a proposed modular building.

The multifunctional panel 20 can also form the exterior skin of the building, such as for the roof or external sidewall of the building. The panel 20 can further provide the ability to control and automate building management functions that enhance the interior environment of the building. The multifunctional panel 20 can also be used to provide an energy-efficient, energy-neutral, or even an energy-positive building. The panel 20 can also be used to fabricate a “smart” modular building which is self-regulating or adaptive to different ambient environments or which can be tailored to specific climate environments or needs of its users. A smart building made using such panels 20 can adapt to different lighting, thermal management, humidity and other ambient conditions, which would otherwise require a custom on-site fabricated design for each site, environment, or specific user needs. The effective use of the panels 20 in a building can make the activities of the inhabitants more effective as human behavior and user equipment can be programmed into the electronics of the panel to respond better to certain ambient conditions which can be optimized by the panels without active management or action by the users. The multifunctional panels 20 also make building solutions less expensive to operate in a large variety of environments because they can greatly reduce the requirements for off-site generated fuel and can be adapted to different architectural applications.

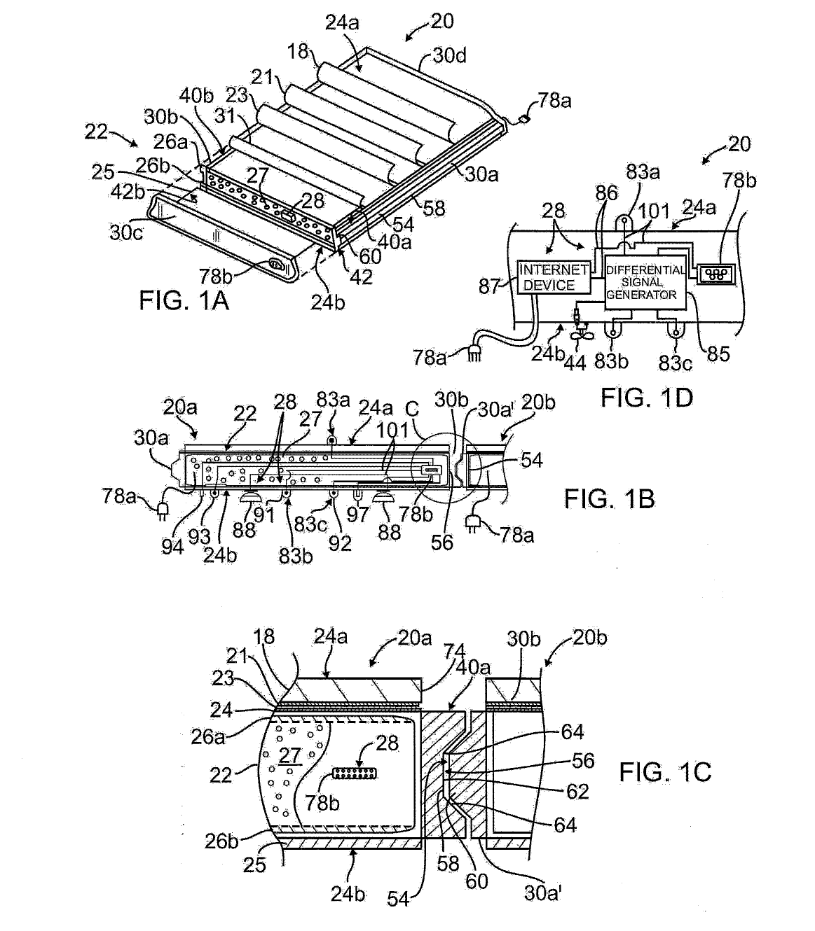

An exemplary embodiment of a multifunctional panel 20 is shown in FIGS. 1A to 1D. The multifunctional panel 20 comprises an insulative body 22, an exterior surface 24a, and an interior surface 24b that opposes the exterior surface, i.e., it is on the other side of the exterior surface. Either of the insulative body 22, exterior surface 24a, or interior surface 24b, can be made from a single material or a number of different materials in the form of sheets or layers to form the desired structure. While exemplary illustrative embodiments of the structure of different multifunctional panel 20 are described herein, it should be understood that the panel 20 can be made from a variety of different solid or molded materials, sheets or layers; thus, the scope of the present invention should not be limited to the illustrative embodiments described herein. The exterior and interior surfaces 24a,b, respectively, are separated by a distance to form an enclosed volume which contains the insulative body 22. In one version, the distance between exterior surface 24a and interior surfaces 24b comprises a distance of from about 5 to about 20 cm. However other sizes are possible depending on the application of the panel 20.

The multifunctional panel 20 can also be joined to other panels with end fittings or couplings to present a continuous weather resistant exterior surface and a fungible, smooth, interior finish surface. In one version, the exterior surface 24a comprises a weather resistant surface 18, by which it is meant that the surface 24a is waterproof to provide a moisture and rain barrier. The weather resistant surface 18 can also be a weather impact surface that protects the panel 20 and the interior of the building from impact damage—for example, damage caused by rain, ultraviolet solar damage, and more significant hazards such as hailstones, flying debris, snow, etc. It also serves as a weatherproof shield which greatly reduces passage of moisture to a waterproof membrane 21 that ultimately protects against moisture entering into the building structure. Suitable weather impact surfaces 18 include wood, composite recycled materials, metal sheets (such as a flat, ribbed or corrugated metal sheet), impact resistant polymer, or any other suitable type of roofing or exterior wall material that can accept long-term exposure to natural elements without significant decay.

In the version shown, the exterior surface 24a includes a waterproof membrane 21 that extends across the upper surface of the panel 20. The waterproof membrane 21 is provided to waterproof the underlying structure of the multifunctional panel 20. The waterproof membrane 21 resists water passage and is suitable for continuously wet environments as well as locations that experience dry and wet weather cycles. A building or structure is waterproofed to protect contents underneath or within as well as protecting structural integrity. Further, the entry of water into the interior of the panel can affect any devices in the panel, and it is desirable to protect from electrical shorting caused by water. For example, a suitable waterproof membrane 21 includes one or more layers of membranes made from materials such as bitumen, silicate, PVC, and HDPE. The waterproof membrane 21 acts as a barrier between exterior water and the building structure, preventing the passage of water.

The exterior surface 24a can also be, or have adjacent to it, a radiant barrier sheet 23 to reduce undesired radiant wave energy transfer from the exterior to the interior and thus, reduce building heating and cooling energy usage. The radiant barrier sheet 23 can also include a gap to serve as an air barrier that allows ventilation between the exterior surface and the waterproof membrane. This gap allows for the passage of air and the shedding of water that penetrates the weather impact surface 18. The radiant barrier sheet 23 reduces air-conditioning cooling loads in warm or hot climates. The radiant barrier sheet 23 can be placed adjacent to the waterproof membrane or lower down in the structure of the body 22. The radiant barrier sheet 23 comprises a thin sheet of a highly reflective material. The radiant barrier sheet 23 can also be a coating of a highly reflective material applied to one or both sides of a sheet such as paper, plastic, plywood, cardboard or air infiltration barrier material. A suitable radiant barrier material comprises aluminum, such as a sheet of aluminum. The radiant barrier sheet 23 has a high reflectivity or reflectance (e.g., a reflectivity of at least 0.9 or 90%). Reflectivity is determined as a number between 0 and 1 or a percentage between 0 and 100 of the amount of radiant heat reflected by the material. A material with a high reflectivity also has a low emissivity of usually 0.1 or less. An air gap is marinated adjacent to the reflective surfaces of the radiant barrier sheet to provide an open air space to allow reflection of the radiant energy and air circulation to remove the radiant energy from the panel surface. This gap also serves to reduce the collection of moisture on the radiant barrier sheet 23 and the waterproof membrane 21. In summer, the radiant barrier sheet 23 operates by reflecting heat back towards the external environment from the roof or wall to reduce the amount of heat that moves through the panel 20 and into the building. In winter, the radiant barrier sheet 23 reduces heat losses through the ceiling or walls of the building in the winter.

Optionally, building paper 31 can be placed, for example, between the waterproof membrane 21 and the radiant barrier sheet 23 as shown in the version of FIG. 1A. The building paper 31 serves as a secondary moisture-resistant and impermeable covering. Typically, building paper 31 is an asphalt-impregnated paper that comes in different weights. For example, building paper 31 comprising 15-lb paper is used for most roofing and moisture-sealing wall applications. Building paper 31 also includes felt paper, tarpaper, roofing paper, or roofing underlayment. Building paper 31 resists air and water getting into the structure but allows moisture to diffuse through it through fine pores in the paper that are sufficiently small to prevent penetration of water through the surface of the paper.

In one version, the interior surface 24b is a surface of an interior board 25. In one example, the interior board 25 comprises a fungible composition panel that extends across the entire lower surface of the panel 20. The interior board 25 is freely exchangeable or replaceable, in whole or in part, for another sheet of a similar nature or kind. The interior board 25 forms the exposed interior surface of the panel 20. The interior board 25 can have color or texture that provides an aesthetic interior ceiling or wall surface of the modular building 100. The interior board 25 can also be useful to hide electrical connections within the roof panel 20. In still another version, the interior board 25 comprises a coating made of a material that absorbs sound, provides additional thermal insulation, and/or is electrically insulating. The interior board 25 may also be separated from the exterior surface of the roof panel 20 by a distance of from about 5 to 20 cm to provide acoustic and thermal insulation between the interior and the exterior surfaces of the roof panel 20. When this sheet is used, the interior board 25 forms the interior facing surface 24b.

The insulative body 22 serves as a structural insulated panel to provide both mechanical or structural support and thermal insulation. In one version, the insulative body 22 comprises first and second structural boards 26a,b that are aligned to one another, as shown in FIG. 1A. The structural boards 26a,b can be oriented strand board, plywood, pressure-treated plywood, cementitious panels, steel, fiber-reinforced plastic, magnesium oxide or other sufficiently structurally sound materials. In one version, this gap or volume between the first and second structural boards 26a,b is filled with an insulating layer 27, as shown in FIG. 1A In one version, the insulating layer 27 serves as a support for, and provides rigid separation between, the structural boards 26a,b. The insulating layer 27 can comprise a material having a selected resistance to heat flow (which is termed an R-value) of greater than about 3.5 per 2.5 centimeters to provide some thermal insulation between the first and second boards 26a,b. The insulating layer 27 can be a foam such as expanded polystyrene foam, extruded polystyrene foam or polyurethane foam, soy or other organic bio-based materials as well as conventional fibrous or cotton insulation materials. The insulating layer 27 of the body 22 can be made using conventional construction techniques, including foam injection process in which the foam bonds directly to the structural boards 26a,b, providing a high bond strength.

In addition, the insulative body 22 can contain devices 28, such as energy storage devices 81, data and power connection devices 78, fans 44, one or more sensors 83a-c (the sensors 83a-c may be the same as sensors 154R), lights 88, and other such devices, as for example, shown in FIGS. 1A-1C and 3. In one version, the insulative body 22 of the panel 20 can also have energy storage devices 81 that store energy in the panel 20. For example, the energy storage devices 81 can be a set of batteries 82. Each battery 82 comprises a rechargeable or storage electrochemical cell, typically comprising a group of two or more secondary cells which are capable of an electrochemical reaction that releases energy and is readily reversible. The rechargeable electrochemical cells accumulate electrical charge using cell chemistries such as lead and sulfuric acid, rechargeable alkaline battery (alkaline), nickel cadmium (NiCd), nickel metal hydride (NiMH), lithium ion (Li-ion), and lithium ion polymer (Li-ion polymer). For example, the batteries 82 can be charged by the electrical energy generated by a photovoltaic array, windmill-generated electrical power, or mains power from an electrical grid 80.

In the version shown in FIG. 3, the batteries 82 comprises a battery sheet 89 extending across a lower surface of the panel 20—for example, between the side splines 30a-d. The battery sheet comprises a sheet of a plurality of batteries 82 having terminals 99 which are interconnected to one another or other devices 28 via electrical cables 101. The battery sheet 89 can be sized to have a thickness of less than 20 mm, for example, or even less than 10 mm or even about 2 mm, and cover an area of the entire surface of the panel 20. An insulating material 27 or other filler can be used to fill the body 22 of the panel 20 to fill spaces between the batteries to provide thermal or electrical insulation.

The panel 20 can also have structural reinforcements around the body 22 of the panel. In one version, a pair of first and second side splines 30a, 30b, are provided at the edges of the body 22 to structurally bridge the gap between the first and second structural boards 26a,b. The splines 30a, 30b also seal off the insulating layer 27 from the external environment to provide a weather- and water-proof seal that reduces environmental or moisture degradation of the material or devices 28 in the insulative body 22. Further, the splines 30a, 30b can be shaped to allow interconnection of one panel 20 to another or to connect devices 28 in the building to the panel 20. The splines 30a, 30b each form a longitudinal segment having a length sufficiently long to extend across substantially the entire length of the panel 20. The splines 30a, 30b can have upper surfaces 40a, 40b that face the exterior of the building and lower surfaces 42a, 42b that face the interior.

In a further version, portions of the panels 20 such as the splines 30a, 30b, can have matching mechanical coupling elements that serve as interconnect features to join a number of panels to one another as shown in FIGS. 1B and 1C. For example, in the version shown, the outside sidewall of the first side spline 30a comprises a tongue 54 that is adapted to mate with, or fit into, a corresponding groove 56 of the outside sidewall of the second side spline 30b of the current panel 20. Referring to FIG. 1C, the tongue 54 comprises an outwardly extending ridge 58 having rounded corners 60, and the corresponding groove 56 comprises a longitudinal slot 62 having rounded edges 64. Two panels 20a,b can be coupled together by fitting the tongue 54 of the first side spline 30a into a corresponding groove 56 of the second side spline 30b. While a tongue and groove design is used to illustrate an exemplary version of an interconnect feature, it should be understood that other interconnecting or coupling elements can also be used as would be apparent to those of ordinary skill in the art. For example, the first side spline 30a can have an upper projecting ledge that slides over a lower projecting ledge of the second side spline 30b (not shown). In another version, the first side spline 30a can have a number of outwardly projecting and spaced apart balls that fit into correspondingly shaped apertures formed in the right-side spline 30b. In still another version, the first side spline 30a can have a “J” shaped upper flange that fit into correspondingly inverse “J” shaped lower flange formed in the second side spline 30b.

Optionally, the front and back ends of the body 22 of the panel 20 can be capped by third and fourth side splines 30c, 30d (which can be also called end or capping splines) to seal off the material or air in the body 22 from the external environment. The side splines 30c, 30d also enable connection of the panel ends to other panels or building components. The side splines 30c, 30d are fastened perpendicular to the side splines 30a, 30b, and can also include corner splines. In the version shown, the side splines 30c, 30d each comprise a flat beam without projecting coupling sections. However, the side splines 30c, 30d can have outwardly projecting coupling sections or other structures as would be apparent to those of ordinary skill in the art to allow coupling to other panels or to a frame of a building.

In one version, the multifunctional panel 20 with side splines 30a-d is sufficiently rigid and mechanically strong to serve as a structural roof member or even replace ceiling joists of a modular building. Also, any of the side splines 30a-d can be made by extruding a suitable metal. For example, the side splines 30a-d can be made by extruding aluminum or steel using conventional methods. Other materials, such as composite or polymer materials can also be used as would be apparent to those of ordinary skill in the art.

The multifunctional panel 20 further includes one or more signal couplers 78a,b that serve as input and output terminals to transmit an electrical signal or electrical power. For example, the signal couplers 78a,b can transmit a sensor signal to other multifunctional panels 20′, receive an input signal from another multifunctional panel 20′, or pass power to power a device 28 in or about the insulative body 22 of the panel. The signal couplers 78a,b can also send output signals to other panels 20 or devices 28, receive input signals from other panels 20 or devices 28, transmitting or receiving a signal to or from a controller 90, form connections to and from data cables 86, or pass a power signal to power a device 28 anywhere in the building. The electrical signals transmitted by the signal couplers 78a,b can be electrical signals, such as analog signals or data signals. The signal couplers 78a,b can, for example, receive a signal from a sensor, photovoltaic cell, battery, heater, cooler, electrical grid, etc. and then transmit the signal to another device 28 in the building to control operation of the building. In this manner, the signal couplers 78a,b allow different panels 20a,b to communicate to one another and to the controller 90, thereby serving as “smart” panels that can communicate information, transmit sensor data, or even receive signals to operate a device 28 located within the panel 20 or adjacent to the panel 20. In embodiments, the information and/or data may be communicated to or received from a platform 102. In one version, the signal couplers 78a,b include an electrical male plug (such as that shown by 78a) and a female socket (such as that shown by 78b) to receive the plug. For example, a suitable plug and socket system can be a multi-pin connector, such as an RS-232 plug and/or socket, a DIN plug/socket, a USB plug or socket, or other types of plugs and sockets. Each set of signal couplers 78a,b comprises pins to receive and transmit signals to signal couplers in other panels 20 or to the controller. These electrical signals control operation of the building and can include electrical power, sensor signals, or operational instructions from a controller. While a wired version of the signal couplers 78a,b is shown, the signal coupler can also be a wireless version, e.g., a wireless modem card or infrared signal transmitter and receiver.

In the version shown in FIG. 1A, a pair of signal couplers 78a,b are mounted in the side splines 30c, 30d, respectively, of the panel 20 to connect the panel 20 to other panels or to external systems. The signal coupler 78a serves as an input terminal and can include a multi-pin connector plug that mates with a matching output terminal comprising a multi-pin connector socket of the signal coupler 78b. The multi-pin connectors comprise connection pins that are capable of transmitting electrical power as well as data for other systems such as a sensor signal from an integrated sensor, electrical power from a photovoltaic cell array or battery, or even mains electrical power. The multi-pin connector's data pins may also be used to input data to a controller within the panel 20 or a controller 90. The signal couplers 78a,b can also be integrated into a multi-pin connector system. The multi-pin connector can include connection pins that are capable of outputting electrical power as well as data for other systems such as output from integrated lights, sensors, mains power, and batteries, as explained below. The multi-pin connector's data pins may also be used to input data to a controller within the panel 20 or outside and in the building structure.

The signal coupler 78a,b can also be of other types. For example, the signal couplers 78a,b can be radiofrequency signal couplers such as an RF transmitter and receiver. The signal couplers 78a,b can also be incorporated into an internet device 87 and thus have a unique IP address. The radiofrequency signal coupler receives and transmits signals to other such devices within other panels or to a radiofrequency signal coupler mounted in electrical communication with the controller. Advantageously, only a single radiofrequency signal coupler is needed per panel as the device can function both to receive signals and transmit signals. In addition, the radio frequency signal coupler does need electrical wires to communicate with other devices or to receive or transmit signals. This facilitates installation of the “wireless” panels in the modular building.

Instead of, or in addition to, the signal couplers 78a,b, the panel 20 can also include a switch 96 to a turn a device 28 on or off in response to the interior sensor signal, exterior sensor signal, or both. The switch 96 can connect an electrical power source, such as the energy storage device or electrical power from the main electrical grid, to a device 28 such as a fan 44, lights 88, heater, cooler, air-conditioning unit, vent, or many other devices, to operate the device 28 in relation to the signal received from one or more sensors 83a-c. For example, the switch 96 can turn on, or turn off, a device 28 such as a fan 44, air conditioner, or heater, or open a vent in the building in response to a signal from a temperature sensor which indicates that the building is excessively hot or too cold. As another example, the switch 96 can generate a switch signal to operate an external device 28 in the same or another panel 20.

Referring to FIG. 1B, various devices 28 which are useful in the building can be attached directly to a panel 20 and located abutting or adjacent to the panel or positioned in other areas of the building but with an electrical connection to the panel 20. For example, a device 28—such as a light 88—can be attached to the interior surface 24b of the panel 20. In one version, the light 88 is directly electrically coupled to the output terminals of an array of photovoltaic cells or to batteries, as explained below. When the light 88 comprises a direct current (DC) powered source, advantageously, the light can be powered directly by the DC voltage output of the solar cells without inverting or rectifying this voltage. This significantly improves the energy efficiency of the light and solar cells. Other direct current devices 28, such as fans 44 or motors or hydraulics to operate vents and skylights, can also be used instead. Any of the DC devices 28 have the benefit of not requiring conversion of the DC voltage generated by the solar cells to alternating current (AC), thereby avoiding the inefficiency of DC to AC conversions, the cost of rectifiers, and less heat generation.

The multifunctional panel 20 can also have one or more sensors 83a-c that function with the signal couplers 78a,b to form a close control loop with a controller or with other panels as shown in FIGS. 1B and 1C. The sensors 83a,b can be mounted on the exterior surface 24a or the interior surface 24b of the panel 20 or both sides. For example, one or more exterior sensors 83a can be used to measure an exterior condition of the exterior environment from the exterior surface 24a of the panel 20 and generate an exterior-condition signal, and one or more interior sensors 83b and/or 83c can be used to measure an interior condition of the interior of the modular building from the interior-side of the panel 20 and generate an interior-condition signal. The interior and exterior condition signals can be evaluated by a device inside or outside the panel 20 to operate another device in the building or attached to a panel 20. While two sensors are shown, it should be understood that a single sensor 83 that can measure both the interior and exterior conditions can also be shown.

A differential signal generator 85 can be used to receive the interior-condition and exterior-condition signals from the sensors 83a-c to evaluate the signals. In this version, the differential signal generator 85 comprises electronic circuitry to generate a sensor signal that is a differential signal which is calculated in response to the differential between the measured interior and exterior conditions. A single sensor 83a having a built-in differential signal generator can also measure both the interior and the exterior conditions and generate a sensor signal in response to the differential between the measured interior and exterior conditions. The differential or direct sensor signals convey information about the interior or exterior building environment via differential or other measurements from the interior and exterior and transmit the information via the signal couplers 78a,b to other panels 20 or to the controller 90 which, in turn, evaluate the sensor signal and regulate operation of the building in response to the sensor signal to provide a self-regulating automated modular building. The sensors 83a-c can be, for example, a temperature sensor, humidity sensor, light sensor, air quality sensor, sound sensor, electrical sensor (such as a voltage or current detector), and other types of sensors. Thus, the sensors 83a-c enhance operation of the building by providing sensor signals for the controller, another panel 20, or another building device, such as a light, fan heating or cooling system, or even motorized shutters. The sensors 83a-c can also activate a phase change material within the insulative body of the panel 20.

In one version, the sensors 83a,b include a temperature sensor 91 that is used to measure the ambient temperature in the interior of the building, a room of the building, and/or an ambient exterior temperature outside the building. The temperature sensor 91 generates a temperature signal in relation to the measured interior and exterior ambient temperatures, this signal being used to adjust the heating and cooling systems to control the temperature in the building. Suitable temperature sensors 91 include, for example, a thermocouple, resistance temperature detector, or bimetallic sensor. The temperature sensor 91 measures the temperature adjacent to the panel or at an interior section of the building and transmits the temperature measurement via the signal couplers 78a,b to other panels 20, to the controller 90, or to devices 28. The temperature signal is then used to control or regulate the temperature within the building, e.g., by increasing or decreasing the building heater power level, operating ceiling fans 44, opening motorized windows or shutters, or opening skylights.

In another version, the sensors 83a,b include a light sensor 92 that is capable of detecting and measuring the ambient light intensity in the interior of the modular building 100 and generating an ambient light signal in relation to this measurement. The signal couplers 78a,b transmit the ambient light intensity signal provided by the light sensor 92 to other multifunctional panels or to the controller. The light sensor 92 can be a photovoltaic sensor or other light-sensitive sensors. The ambient light signal of the light sensor 92 is used to turn on or off or to diminish different lights 88 to increase or decrease the intensity of light within the building or even open motorized shades or shutters in windows, thereby increasing or decreasing interior light on a self-regulating, as-needed basis to the interior of a building. For example, as cloud cover reduces available natural light below desired levels or the day darkens into evening, the diminishing light signal from the light 92 sensor can be used to increase power supplied to lights in the interior of the building to open or close shades, etc. The light sensor 92 can also be mounted on the exterior surface 24a to measure the outside light conditions to control exterior lights. In one version, a first light sensor 92a is mounted on the interior surface 24b to measure an ambient light intensity of the interior of a building, and a second light sensor 92b is mounted on the exterior surface 24a to measure an ambient light intensity of the exterior of the building. The differential signal can be used to control the intensity of the lights in the building, or each of the interior and exterior light intensity signals can be used to set the light intensity inside or outside the building respectively.

In still another version, the sensors 83a,b include a humidity sensor 93 mounted on an interior surface 24b to measure a humidity level of the interior and/or exterior of the building and generate a humidity signal in proportion to the measured humidity levels. The signal couplers 78a,b transmit the humidity signal to other multifunctional panels or to the controller. For example, a suitable humidity sensor 93 can be a relative humidity sensor.

In yet another version, the sensors 83a,b include an air-quality sensor 94 mounted on the interior surface 24b to measure an air quality of the interior of the building 100 and/or mounted on the exterior surface 24a to measure an air quality of the exterior of the building 100. The air-quality sensor 94 continuously monitors the air quality and generates an air-quality signal that is sent via the signal couplers 78a,b to other panels or a controller. The air-quality signal provides energy savings through demand-based control of outside air intake, improves and optimizes the air quality of the facility, and can even identify potential air quality problems in the early stages. A suitable air-quality sensor 94 comprises an oxidizing element that, when exposed to gases in an environment, changes in resistance depending on the chemical composition of the gases and provides an output air-quality signal that corresponds to the combined concentration of a number of contaminant gases typically found in indoor environments. This provides a much more accurate representation of the actual air quality than, for example, a CO or CO2 sensor which senses only CO or CO2 and not other contaminant gases. An exemplary version of a suitable air-quality sensor 94 comprises a BAPI Room Mount Air Quality Sensor™ fabricated by Building Automation Products, Inc., Wisconsin. The output air-quality signal generated by the air-quality sensor 94 is transmitted to the controller which evaluates the signal and generates an output signal to control the amount of outside air introduced by a ventilation plant into the building. By controlling ventilation, the system reduces energy consumption by eliminating the introduction of excess outside air into the building during periods of little or no occupancy.

In still another version, the sensors 83a,b include a sound sensor 97 mounted on the exterior surface 24a or interior surface 24b to measure the ambient sound levels outside or inside the building. The sound sensor 97 can measure decibel levels. The sound sensor 97 can be a conventional microphone. The signal from the sound sensor 97 can be used to lower sound absorbing curtains if the ambient noise in the building is too high, close windows if the exterior noise levels are too high, and other such functions.

The panel 20a can also have an internet device 87 with an internet protocol address, as shown in FIG. 1D. The internet device 87 can be, for example, an integrated circuit chip with attached memory, a programmable logic chip, a wired or wireless modem, or a router. The Internet Protocol (IP) is a protocol used for communicating data across a packet-switched internetwork using the Internet Protocol Suite, also referred to as TCP/IP. IP is the primary protocol in the Internet Layer of the Internet Protocol Suite and has the task of delivering distinguished protocol datagrams (packets) from the source host to the destination host solely based on their addresses. For this purpose, the Internet Protocol defines addressing methods and structures for datagram encapsulation. Current versions include Internet Protocol Version 4 (IPv4) and Internet Protocol Version 6 (IPv6). An Internet Protocol (IP) address is a numerical identification and logical address that is assigned to a device participating in a computer network utilizing the Internet Protocol for communication between its nodes. Although IP addresses are stored as binary numbers, they are usually displayed in human-readable notations, such as 208.77.188.166 (for IPv4) and 2001:db8:0:1234:0:567:1:1 (for IPv6). The IP address includes a unique name for the device, an address indicating where it is, and a route indicating how to get there. TCP/IP defines an IP address as a 32-bit or 128-bit number. The Internet Protocol also has the task of routing data packets between networks, and IP addresses specify the locations of the source and destination nodes in the topology of the routing system. A data cable 86 is used to enable communications amongst the devices within the insulative body, such as the sensors 83 and internet device 87, and it can also be connected to the signal couplers 78a,b to network with other panels 20b as well as the controller 90. In embodiments, the panel 20 may contain a processor. In embodiments, the panel 20 may function as a server. In embodiment, the panel 20 may be capable of running monitoring software 158R.

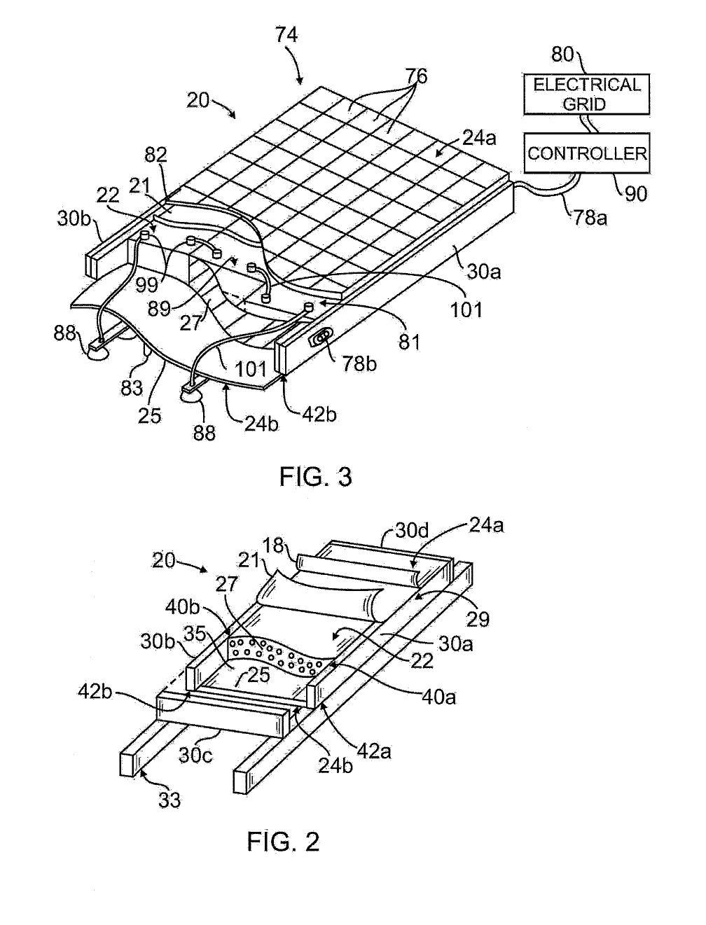

Another version of the multifunctional panel 20 comprises an insulative body 22 that has more rigidity to serve, for example, as structural roof member or even replace ceiling joists of a modular building. In the version shown in FIG. 2, the structural panel comprises a frame 29 comprising a pair of side splines 30a, 30b that oppose one another. The side splines 30a, 30b have upper surfaces 40a, 40b and lower surfaces 42a, 42b, are parallel to one another and span across the entire length of the panel 20 to define the left and right edges of the panel 20. The side splines 30a, 30b are connected at their ends by the side splines 30c, 30d to form an enclosed interior volume 35. Typically, the side splines 30a-d are configured to define a rectangular interior volume 35, such as the parallelogram or cube. The interlocking surfaces of the panels formed at the junctions of the side splines 30a-d in the embodiment shown can be joined by conventional means, such as welding, nuts and bolts, or brazing. The side splines 30a-d can also be braced with right-angled supports (not shown) at their corners for additional support. The geometry of the planar roof panel 20 facilitates welding or fastening the panel 20 in-place to a roof section 33. For example, a set of fasteners 37 comprising screws, nails, or clips can be used to fasten the roof panel 20 to a roof joist 115 of a roof.

In this embodiment, side splines 30a-d are all shown as solid longitudinal beams; however, it should be understood that other structures equivalent to the longitudinal beams can also be used, such as a plurality of interconnected X-structures, multiple beams joined by vertical members, a honeycomb structure, or other structures as would be apparent to those of ordinary skill in the art. The side splines 30a-d can be fabricated from metals such as steel, stainless steel, or aluminum.

The panel 20 also has an exterior facing surface 24a formed of a layer, such as a waterproof membrane 21, and the interior surface 24a can be that of an interior board 25. The interior and exterior facing surfaces 24a,b extend between splines 30a-d to enclose interior volume 35. The interior volume can be empty space or can have an insulating layer 27 (as shown), or batteries 82 (not shown). The volume 35 serves as insulation, vapor and air barrier between the inside of the building and the external environment. In one version, rectangular interior volume 35 is filled with an insulating layer 27 such as a foam or fiber mat.

In yet another version, the multifunctional panel 20 comprises an exterior surface 24a having a photovoltaic array 74 comprising an array of photovoltaic cells 76, as shown in FIG. 3. Such a panel 20 can be mounted on the exterior of the building to generate electricity from incident solar energy. A modular building 100 fabricated with a plurality of such multifunctional panels 20 reduces the amount of energy required to operate the building or may even provide sufficient energy to the building so as not to require a connection to the electrical grid 80. In sunny climates, the building 100 can be outfitted with a sufficient number of multifunctional panels 20 to output enough electricity to power its own lights or other building or user utilities and equipment. The photovoltaic cells 76 can cover a waterproof membrane 21. The photovoltaic array 74 may also require structural framing (not shown) to affix it to the panel 20. The photovoltaic cells 76 convert solar energy into electrical energy by the photovoltaic effect. Assemblies of photovoltaic cells 76 connected to one another in a series and/or parallel arrangement are used to make a photovoltaic array 74. For example, a panel 20 can have a photovoltaic array 74 comprising from 10 to 200 cells or even from 15 to 50 cells. A signal coupler 78a can serve as an electrical output terminal to output the electricity generated by the photovoltaic cells 76.

In one version, the batteries 82 in the insulative body 22 of the panel 20 are electrically coupled to the output terminals of the photovoltaic cells 76. The batteries 82 comprise terminals 99 which are interconnected to one another, to the photovoltaic cells 76, and/or the signal couplers 78a,b via electrical cables 101. The cells 76 charge the batteries 82 during the day, and the electrical power of the charged batteries can be used to operate the light 88 at night. The batteries 82 can also be charged by the electrical energy generated by the photovoltaic array 74 or from other multifunctional panels and/or main power from the electrical grid 80 via a power connection in the signal coupler 78a.

In one version of the panel 20, the array of photovoltaic cells 76 and the batteries 82 are directly electrically coupled to the lights 88 and to the output terminals 78a of the panel 20. When the lights 88 comprise direct current or DC powered lights, they are powered directly by the DC voltage output of the cells 76 without inverting or rectifying this voltage to improve the energy efficiency of the light 88 and cells 76. For example, the electrical cables 101 can connect the positive and negative terminals 99 of the photovoltaic array or a battery sheet 89 to the lights 88.

The array of cells 76, batteries 82, sensors 83, differential signal generator 85, internet device 87, and signal couplers 78a,b can also be connected to a controller 90, such as an external controller located elsewhere in the building or an internal controller built into a particular panel 20. The controller 90 can include a central processing unit (CPU), such as an Intel Pentium or other integrated circuit, a memory such as random access memory (RAM) and storage memory such as an electronic flash memory or hard drive, and connectors for connecting input and output devices such as keyboards, mice and a display. The controller can also contain a software program comprising program code to receive electrical signals from any of the devices 28, including the signal couplers 78 a,b, sensor signals from the sensors 83a-c, power from photovoltaic cells 76 or the electrical mains, and control the signals returned to the devices 28. For example, the controller 90 can receive a signal from a light sensor 92 that indicates the ambient light levels in the building, and send an output signal to connect the lights 88 to a voltage source such as the batteries 82 or the electrical grid mains 80 depending on the external light conditions or power cost. The controller 90 can also serve as a central information source to contain data generated by the sensors or libraries of data, logic, programs, etc. The controller may execute monitoring software 158R.

The controller 90 can also be linked to an off-site data storage and processing server to enable communication with other controllers as well to receive information external to the site but that may optimize operation of the smart system. This external information could include weather forecast information including projected temperature, wind, sun, humidity and other data for the controller 90 to anticipate required operation of the smart panels linked to the controller 90. For example, if the weather forecast anticipates a storm, the controller 90 can shut windows in the building before the storm hits the building.

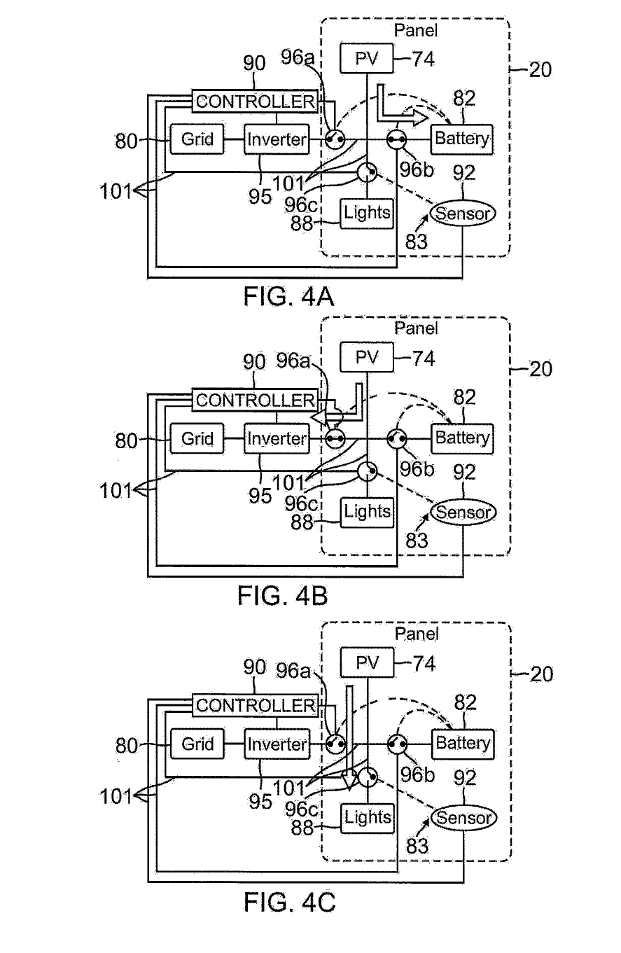

FIG. 4A-C are electrical block diagrams showing the circuit connections to transfer electrical power generated by the photovoltaic array 74 to an electrical grid 80, battery 82, or lights 88, respectively. These devices are interconnected by the electrical cables 101 and switches 96a-c are provided to control the flow of electrical power. An inverter 95 is provided to convert the DC voltage provided by the photovoltaic array 74 into an AC voltage suitable for passing to the electrical grid 80 or powering AC devices in the building. FIG. 4A shows the electrical connections made when the switch 96b is closed and the current from the photovoltaic array 74 is used to charge the battery 82. In this mode, the switches 96a,c are left open while the battery is charging. FIG. 4B shows the electrical connections made when the switch 96a is closed and switches 96b,c are left open, causing the current from the photovoltaic array 74 to be passed through the inverter 95 and back to the electrical grid 80 to obtain an electrical power discount. This allows the grid-tied electrical system to feed excess electricity generated by the photovoltaic array 74 back to the local mains electrical grid. When insufficient electricity is generated or batteries 82 are not fully charged, electricity drawn from the mains grid 80 makes up for any short fall. FIG. 4C shows the electrical connections made when the switch 96c is closed and the current from the photovoltaic array 74 is used to power the lights 88 or other devices in the building. The switches 96a-c can be manually operated or operated using the signal from sensors 83 such as a light sensor 92.

Optionally, a controller 90 which serves as a central information resource can also be used to control the various switches 96a-c, inverter 95, sensors 83 such as the light sensor 92, and other devices. The controller 90 can be a separate device or can be integrated into the inverter 95 or other device. The controller 90 can also be built into one of the panels 20. For example, the switches 96a-c can be manually operated or operated using sensors 83 such as a light sensor 92, or using software code embedded in the controller 90. In this version, the controller 90 comprises software code to receive a input signal from a sensor 83, such as an interior building light or external light output signal from a light sensor 92, a humidity level signal from a humidity sensor, a temperature signal form a temperature sensor, or other. The controller 90 can also receive a signal from the photovoltaic array 74 indicating generation of electrical power (or not) or the battery 82 indicating a fully charged state or a depleted charge state. The software code in the controller 90 evaluates the input signal and generates an output signal to control the switches 96a-c to charge the battery 82 by closing the switch 96b and directing the output of the photovoltaic array 74 to the battery 82, or close the switch 96a to send excess power generated by the photovoltaic array 74 to the inverter 95 and back to the electrical grid 80, or close the switch 96c to direct DC power directly from the photovoltaic array 74 to the lights 88 or other devices in the building. In this manner, the circuitry associated with a panel 20 can operate the building in a manner that most efficiently utilizes the available solar energy resources or for other ambient conditions.

A kit of multifunctional panels can also be used for a single building. In one version, the kit comprises a sensor panel 20 comprising an insulative body 22 between an exterior surface 24a and interior surface 24b. The contents of the kit may have been determined and/or optimized using the platform 102R. An exterior sensor 83a is used to measure an exterior condition of the building 100 and an interior sensor 83b to measure an interior condition of the building 100, or a single sensor 83 can be used to measure both the interior and exterior conditions of the building 100. The sensor panel 20 also includes one or more signal couplers 78a,b to transmit the sensor signal generated by the sensors 83a,b to other panels 20′, receive an input signal from another panel 20′, or pass electrical power to power a device in or about the insulative body 22 of the panel 20. The signal coupler 78a,b can transmit any one of the interior or exterior sensor signals to other panels 20 or to the controller. The signal coupler 78a,b can also pass a switch signal from a switch 96a-c to an external device 28 in another panel 20. The same kit can also includes a controller panel 20′ comprising an exterior surface 24a, interior surface 24b, and an insulative body 22 there between and a controller 90 to receive a signal from the signal coupler 78a,b to control a device in or about the insulative body 22. Various other panels 20 can also form part of the kit. For example, the kit can include a panel 20 having only a pair of signal couplers 78a,b to transmit an electrical signal from one panel to another or to form a chain of panels to relay a signal from a sensor panel 20 to a controller panel 20′ or to an external controller 90.

Various other types of kits can also be designed for particular applications. For example, a kit of panels 20 for a hot environment or location can include a panel having a device such as an AC or DC powered fan 44, motorized vent, or motorized or hydraulic operable window for opening the panel 20 to allow hot air to escape from the building 100. Still other kits can include panels having devices such as heaters for use in buildings adapted to cold environments. Still further, a kit of panels can include panels comprising signal couplers 78a,b which are wireless to communicate signals from sensors 83 to a central controller 90 inside the building or at a distant location. The kit of multifunction panels 20 or individual panels 20 can be easily shipped and mounted on a roof or wall of a building 100 that is a modular building or kit building. The panels 20 and other structural components of the building are rapidly deployable and easily transportable, minimizing both on-site assembly time and resource consumption.

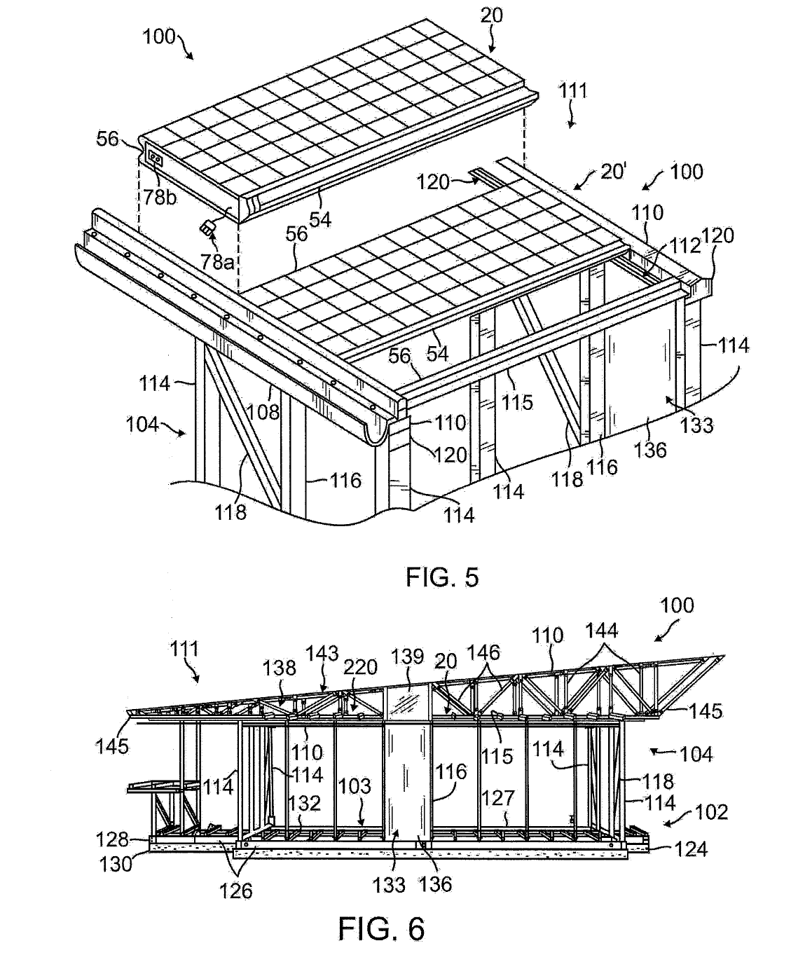

An exemplary and illustrative embodiment of a structural frame of a modular building 100 which can use one or more of the panels or a kit of panels, as shown in FIGS. 5-7. However, it should be understood that the illustrative embodiment of the building 100 herein is not intended to limit the scope of the invention, and the panels 20 and other structures according to the present invention can be used in other building designs as apparent to those of ordinary skill in the art.

In the version shown the building 100 comprises a support sled 102 with a shed 104 and optional side expansion modules 106. The sled 102 serves as a support and base for the shed 104 and can also be used to provide preassembled electrical connections for electrical services and mechanical services, such as ventilation, heating, cooling, and water plumbing. The shed 104 provides an enclosed housing structure that rests on the sled 102 which serves as the interior space of the modular building 100. The expansion modules 106 can be used to expand the interior space of the modular building 100 to provide extra space or to contain facilities such as restrooms, electrical power equipment, or other building service equipment. In the diagram shown, the sled 102, shed 104, and expansion modules 106 have rectangular structures; however, it should be understood that other shapes and structures (e.g., cylindrical or spherical structures) can also be used as would be apparent to those of ordinary skill in the art. Thus, the scope of the invention should not be limited to the illustrative embodiments described herein.

A roof 111 forms the ceiling of the shed 104 and optional expansion modules 106 and can be flat or triangular-shaped or have other shapes. In the version shown in FIG. 5, a plurality of multifunctional panels 20, 20′ comprising a photovoltaic array 74 are fitted together to form a rigid roof of the modular building 100. For example, the multifunctional panels 20, 20′ can be spaced apart to form a roof 111 that spans the width between the trusses 110. The trusses 110 are equipped with attachment surfaces 112 for fastening the roof panels. The multifunctional panels 20, 20′ can be fastened directly to each other and to the trusses 110 and/or fastened to roof joists 115 using conventional fastening means. Each multifunctional panel 20 is interlocking and has tongue 54 and groove 56, respectively, that mate with one another to snap-fit and interlock with one another (as previously described) to form a continuous rigid roof. The roof joists 115 span the length between trusses 110. The trusses 110 rest on and are anchored to the steel frame of the underlying shed 104 (or expansion module 106). A drainage channel 108 can be optionally mounted on an end of the roof 111. The roof 111 formed by the trusses 110, roof joists 115, and panels 20 provide a high-strength structure for situations such as storm or high-snow environments. The panelized roof 111 also allows for quick and easy building assembly on-site and provides a highly flexible and tailorable interior space.

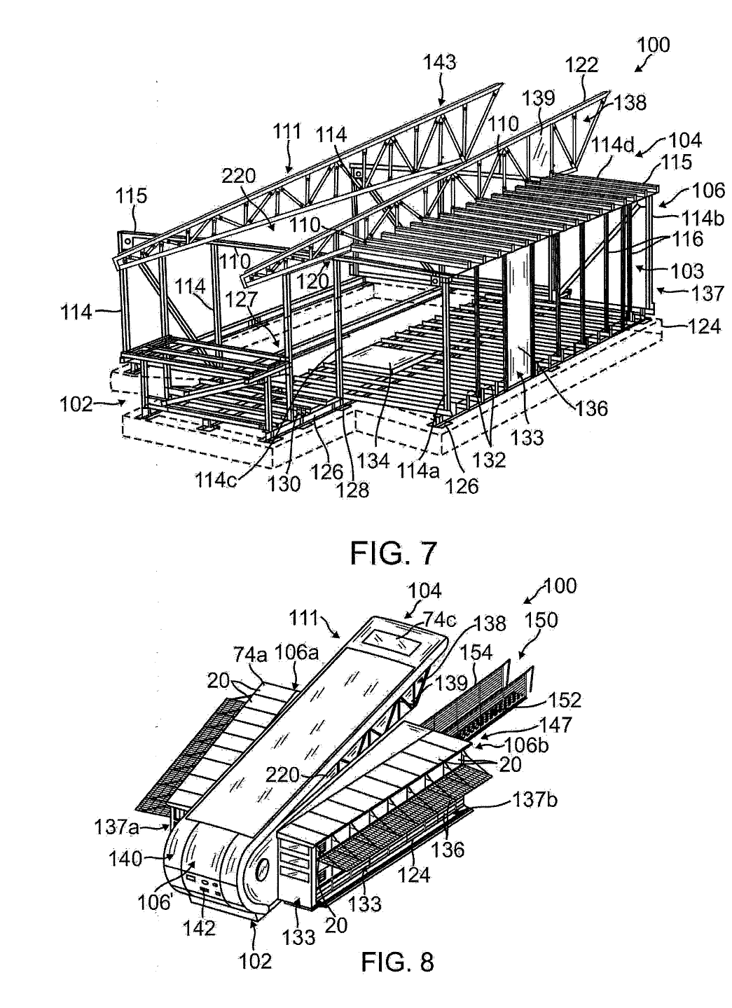

In one version, the building is supported by a sled 102, an exemplary version of which is shown in FIGS. 6 and 7. The sled 102 comprises a rectangular frame 103 composed of wide flange beams 126 that are spaced apart and rest on underlying concrete grade beams 124, leveling stands, and metal plates. The wide flange beams 126 are oriented in a rectangular configuration and are joined to one another by high-strength bolts 128. The sled 102 can be anchored into the concrete grade beams 124 and leveled using cast-in-place or post-poured, drilled, high-strength bolts 128 or the leveling stands and metal plates. The wide-flange beams 126 can even be equipped with custom mounting surface such as welded flat plates 130 that enable them to be mounted to the concrete grade beams 124. The concrete grade beams 124 can be oriented to provide a hollow region 127 underneath the sled 102 for placement of prefabricated electrical and ventilation system devices. The constructed sled 102 provides a preassembled structural platform with good structural integrity and pre-tested bolted and welded connections, allowing a flexible configuration of any overlying shed 104 or expansion module 106.

In another version, the sled 102 has a minimal number of connections to concrete footings, piles, or other site-intensive foundation elements which are sufficient to manage the dead load and lateral load associated with high winds or seismic forces. The connections to the ground allow resting of the load on the ground and holding the structure down in case of extreme wind or other uplifting force.

The sled 102 also has floor joists 132 that extend across the floor to provide structural rigidity. The floor joists 132 can comprise light gauge metal sections or beams. A raised floor is formed from floor panels 134 placed between the framework of the floor joists 132 to provide the necessary structural diaphragm for the base of the shed 104. As one example, the floor panels 134 can be made from structural metal decking. As another example, the floor panels 134 can be composed of concrete-filled metal pans that sit on pedestals so that the underlying cavity can house electrical and mechanical services. The floor panels 134 can also be rearranged to move outlets, ports, and air diffusers, providing the user with maximum flexibility. The under-floor distribution of mechanical services for the overlying shed 104 can include HVAC (heating, ventilation and cooling) tubes, electrical junction boxes, data cabling, and preassembled wiring. Locating electrical and mechanical services underneath the floor of the shed 104 provides an infrastructure for such services and can be tailored without extensive pre-wiring and ventilation planning for the overlying shed 104.

The shed 104 comprises a framework of spaced apart major and minor columns 114, 116, respectively, that each includes beams and braces, such as steel beams. The major columns 114 are located at the corners of the shed 104 and attached to the underlying wide flange beams 126 of the sled 102, and the overlying roof trusses 1120, roof joists 115, and roof panels 20. Minor columns 116 are bolted to the floor joists 132 of the sled 102. In addition, diagonal columns 118 can also be used to brace the structure of the shed 104 and increase its lateral and shear strength. The columns 114, 116, 118 are linked to one another by overhead roof trusses 110 and joists 115, and can be connected by headers 120 (gussets) to provide vertical strength in support of the ceiling. In one version, all these members—namely the columns 114, 116, and 118, roof trusses 110, and other such structural members—are linked together with headers 120 and bolted together for gravity load and lateral strength to achieve predictable structural performance in a wide range of configurations and locations.

The walls 133 of the shed 104 and expansion module 106 can be formed by spacing apart the minor columns 116 a sufficient distance to accommodate wall panels 136 such as light-impermeable or light-permeable panes, such as windows, translucent screens, or even doors. Advantageously, positioning the minor columns 116 a predefined spacing distance provides a highly adaptable exterior sidewall 137 for the shed 104, so that each exterior sidewall 137 can be adapted to allow the transmission of light, serve as an opaque wall, or even provide a solar connection of the interior space of the shed 104 to other structures, such as an expansion module 106. The structure of the shed 104 also enables the two long exterior sidewalls 137a,b (as shown in FIG. 8) to be absent structural reinforcements which are conventionally needed to provide strength in seismic or storm locations, consequently enabling the shed 104 to have a variety of different external wall configurations.

Optionally, the modular building can also include a plurality of expansion modules 106, 106a,b designed to be attached to an open sidewall or end wall of the shed 104 to expand the usable enclosed space provided by the shed 104, as shown in FIGS. 7 and 8. Each expansion module 106, 106a,b comprises an external sidewall 137a,b, and they are linked to the shed 104 by the roof trusses 110 to define an open interior space encompassing the combined area of the expansion modules 106a,b and the shed 104. In the version shown, the expansion modules 106a,b each comprise major columns 114a-d that form the corners of its structural frame, at least two of the major columns 114a,b being external to the shed 104 and two other major columns 114c,d being in a sidewall of the shed 104. The expansion module 106 also has a sidewall 137, 137a,b with minor columns 116 that can be spaced apart as described in the minor columns 116 of the shed 104 to allow spaces for light-permeable panes, doors, or other structures. The expansion modules shown in FIG. 7 extend outward perpendicularly from the shed; however, alternate arrangements are possible, such as wedge-shaped side expansion modules, as shown in FIG. 8.

The building 100 can comprise other expansion modules 106′, such as a power pack module 140 as shown in FIG. 8. The power pack module 140 comprises electrical and mechanical systems suitable for the selected size of the building 100. For example, the power pack module 140 can include a bank of batteries 82 (not shown) with suitable electrical control and monitoring equipment such as the switches 96a-c, inverter 95, and controller 90 (which can be a charge controller) to receive and store electrical power from solar multifunctional panels 20 and distribute stored electrical power to electrical systems within the building 100, such as the lights 88 and ventilation system (not shown). An electrical generator 142 can also be provided in the power pack module 140 to supply additional power to the building 100 and its electrical systems. The power pack module 140 provides a convenient, transportable solution that is preconfigured to the interior volume of the modular building 100 that may include a shed 104 and suitable expansion modules 106.

The roof 111 of the modular building 100 can have variable heights and also provide optional and optimized clerestory natural lighting. As a result, the modular building 100 can be tailored to a wide range of interior environments while still providing a quick-to-deploy modular building 100 that is safe and long-lasting. In one version, the roof 111 comprises roof trusses 110 that are mounted in an angled position to form a tilted roof 111 enclosing a triangular volume. The tilted roof 111 can be equipped with light-permeable panes 139 that serve as clerestory windows along the triangular gap 138 between the roof plane 143 and the walls 133 and sidewalls 137 of the shed 104, as shown in FIGS. 6-8. The tilted roof 111 comprises a plurality of vertical struts 144 and diagonal struts 146 that allow for mounting of the light-permeable panes 139 in a clerestory configuration. In one embodiment, the tilted roof 111 is mounted to the major columns 114 of the shed 104 with hinges 145 that allow for the tilted roof 111 to be folded down to lie flat against the ceiling of the shed 104. The hinged tilted roof 111 allows for the roof of the modular building 100 to be flattened into a horizontal position during periods of high wind conditions, such as what might occur during transportation of the shed by truck to the building site. The ceiling 220 below the tilted roof can be an open ceiling (as shown) or can be an enclosed ceiling formed by the roof panels (not shown). The titled roof 111 provides a rigid framework which also allows easy expansion of the interior space provided by the shed 104 while providing good structural strength in high wind and high seismic applications.

The modular building 100 can also have multifunctional panels 20 located on the walls 133 or sidewalls 137 of the building 100. For example, the multifunctional panels 20 can be positioned on the upper section 147 of the sidewall 137b as shown in of FIG. 8. These panels 20 can be shaped and sized to fit into this space. Further, the panels 20 can have other shapes corresponding to other panels of the building and mounted in other lower positions as well.

The modular building 100 can be customized to include additional components. For example, a handicapped access ramp 150 comprising a rigid tilted surface 152 and hand rails 154 can be provided at an entrance to the shed 104. The access ramp 150 can be configured to allow passage of wheeled devices, such as wheelchairs and strollers, from ground level outside of the modular building 100 to the interior of the shed 104. As another example, a sun shade structure such as an awning 156 can be provided to filter or even block direct sunlight to some or all of the side panels of the modular building 100. The multifunctional panels 20 would enable these additional components to have access to power, data, and other technology directly from the panels. The roof panels 20 can also be supported on peripheral structures, such as the awning 156.

A modular building 100 according to the described embodiments is designed to be self-regulating and easily adaptive to different environments. The modular building 100 also controls lighting, thermal management, humidity, air-quality, acoustics, and other conditions in the building to (i) optimize these conditions for the occupants while increasing the efficiency of these systems to reduce external costs in electricity, water consumption and others, and (ii) create an improved interior environment to support user performance. Also, the modular characteristics of the individual panel elements facilitate future renovation and/or improvement or customization 150R as they may be simply disconnected and replaced, avoiding the demolition of traditional construction renovation. The building 100 incorporate technologies that allow the building to be used in a large variety of situations and environments without requiring redesign of the building structure or components. Further, the panels 20, roof trusses 110, roof joists 115, major and minor columns 114, 116, and the structure of the sled 102, shed 104, and expansion modules 106 combine to form a structural frame of modular building 100 that can be easily transported onto a building site with essentially all labor-intensive and inspection-intensive work—such as welding, drilling and cutting—already completed. This allows the modular building 100 composed of the sled 102, shed 104, and optional expansion modules 106 to be quickly assembled on the site. The pre-manufactured structural components comprise a “kit of parts” that only needs to be joined or partially assembled without extensive on-site alterations to provide a high-performance structure with an adaptable interior configuration. This reduces the impact of the site preparations in grid-connected utility requirements. The structures also reduce risks associated with improper assembly by requiring only minimal skill levels for assembly and equipment usage. The assembled modular building 100 can also withstand the vertical and lateral forces generated in earthquakes and storms. Further, the modular building 100 also reduces on-site construction waste as the precision of the engineering and fabrication process and defined means of on-site installation reduce the material waste that typifies traditional on-site construction. Any excess material is collected at the factory in which the panels are built for recycling.

While illustrative embodiments of the multifunctional panel 20 are described in the present application, it should be understood that other embodiments are also possible. For example, the multifunctional panel 20 can have other shapes and structures and can be made from other materials as would be apparent to those of ordinary skill in the art. Thus, the scope of the claims should not be limited to the illustrative embodiments described herein.

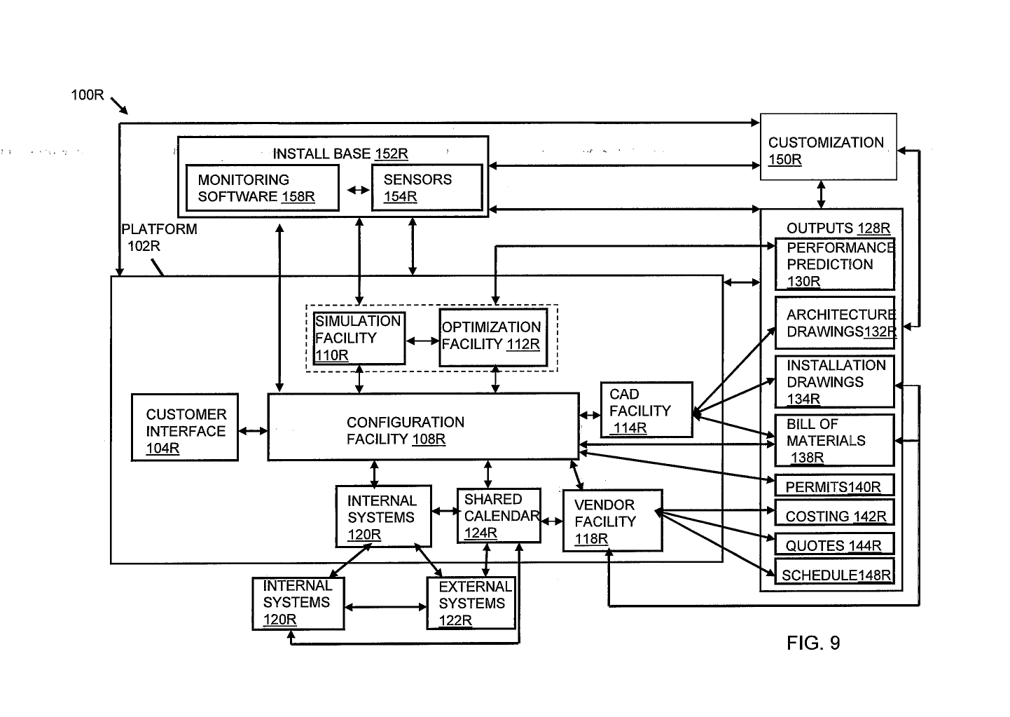

FIG. 9 depicts a modular building platform 102R for designing, optimizing and constructing modular buildings. The methods, systems and inventions disclosed herein are not limited to modular buildings, but may be applied to any type of building or structure. Referring to FIG. 9, the modular building platform 102R may include and/or interface or communicate with various functionalities, features, facilities, engines and the like, including, but not limited to a customer interface 104R, a configuration facility 108R, a simulation facility 110R, an optimization facility 112R, a CAD facility 114R, a vendor facility 118R, internal systems 120R, external systems 122R, a shared calendar 124R, outputs 128R, such as performance predictions 130R, architecture drawings 132R, installation drawings 134R, a bill of materials 138R, permits 140R, costing 142R, quotes 144R, schedules 148R and the like, customizations 150R, an install base 152R, which may contain sensors 154R, monitoring software 158R and the like, and the like.

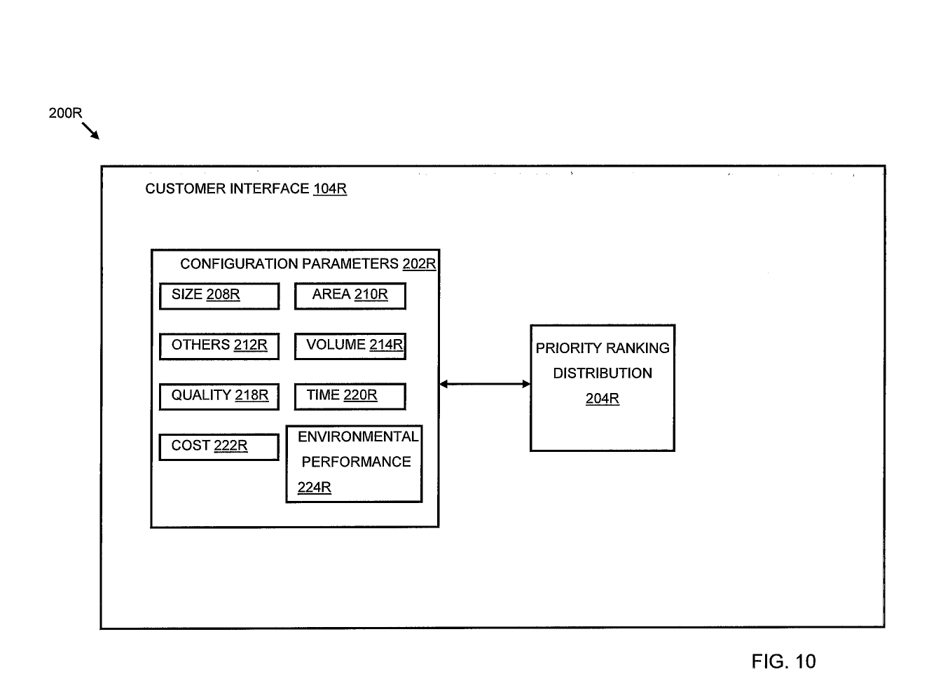

In embodiments, the platform 102R may include a customer interface 104R which may allow a user to specify various configuration parameters, values of all or a subset of those parameters, priorities among those parameters, as well as tolerances and/or a distribution for variances in all or a subset of those parameters, which may be taken into consideration in the design and construction of a modular building. Referring to FIG. 10, the customer interface 104R may accept inputs relating to various configuration parameters 202R and generate a priority ranking distribution 204R for the configuration parameters 202R. The priority ranking distribution 204R may be utilized by the platform in connection with simulations, optimizations and the like. In embodiments, the customer interface 104R may be a software interface, tool and/or wizard.

In embodiments, the configuration parameters 202 R may include size 208R such as external size and internal size, area 210R, volume 214R, quality 218R, time 220R, cost 222R, environmental performance 224R and others 212R. Others 212R may include use, program requirements, configuration, aesthetics, materials, location, level of finish, lead-time, timing, schedule, price, performance, quality, environmental performance, degree of being environmentally-friendly, energy efficiency, speed of delivery, cost, code restrictions (such as building code restrictions, by-laws and compliance with the division of state architect), laws, rules, regulations and the like. The configuration parameters 202R may apply to the building as a whole or a subset of the building, including a modular component, or a location on which the building is to be placed and/or constructed. In a particular embodiment, the configuration parameters 202R may include at least a temperature inside the building. The user can specify an optimum temperature value of 68° F. and can indicate that the user may tolerate a temperature of 73° F. up to 10% of the time and that the user may tolerate up to 7 days each year where the temperature reaches 80° F. In another embodiment, the configuration parameters 202R may include at least a behavior modification which may indicate how willing the user and/or the eventual occupants are to modify their behavior, such as by shifting the hours of the work day or using only one-ply tissues. In another embodiment, the configuration parameters 202R may include at least the construction and/or assembly schedule for the building. The user may set the schedule as well as tolerances for deviations in the schedule. This may allow a user to set a schedule that considers that funding, and possibly payment for the building, will occur in stages, but have little tolerance for missing key milestones that may impact the ability to obtain funding or cause a default under loan agreements and the like.

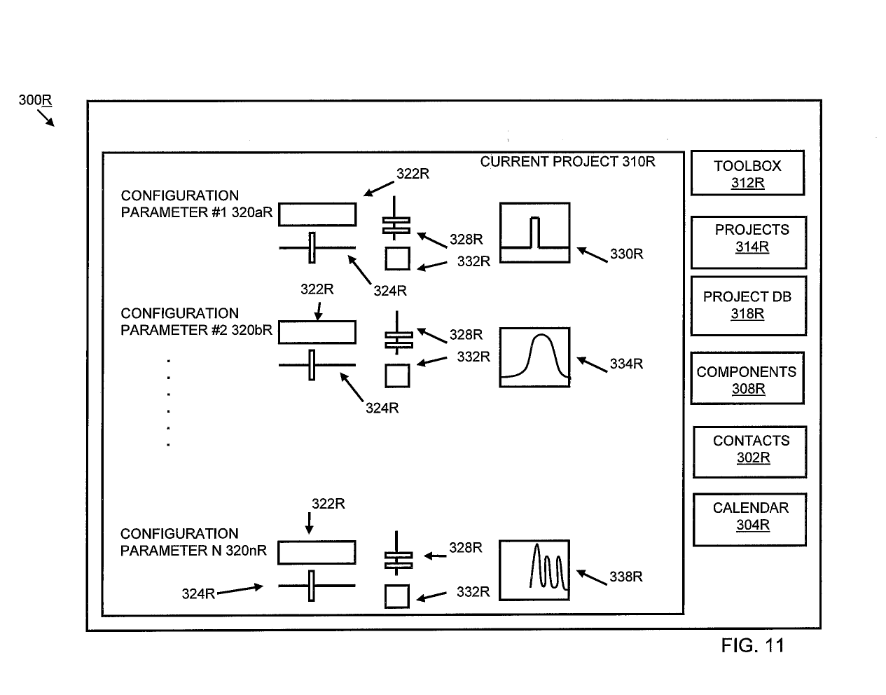

Referring to FIG. 11 a user interface 300R for the customer interface 104R is provided. The user interface 300R may be used to initiate work on and manage a project, interact with other users, search older projects, and the like. A contacts 302R window may allow the customer to maintain a list of contacts, such as architects, clients, vendors, fabricators, consultants, freighters, shippers, contractors, government personnel, and the like. From the contacts 302R window, the customer may initiate contact, such as a chat, an e-mail, an audio call, a video call, a desktop share, an application share, a file share, and the like. A calendar 304R window may allow the user to input/check availability, calculate lead times, view shared calendars of other users, set the schedule for construction and tolerances for deviations, and set a schedule that considers funding, so the building can be constructed in phases with payment for each phase over time, and the like. A components window 308R may list various components and services available for including in a project. The components and services may be selectable for placement in the current project window 310R. The components may be automatically selected once a parameter, tolerance, and/or priority is set. Alternatively, the user may choose to skip setting a parameter, tolerance, and/or priority and select components and/or services themselves.

The current project 310R window may allow the customer to select items, or view those automatically selected, from the components window 308R when a parameter is set, and either drag-and-drop them onto the current project 310R window or select them from the component window 308R and have them appear in the current project 310R window. The components may appear in the current project 310R window either as a list, a list with pictures, as 2-D pictures, or as 3-D representations. The customer may be able to assemble the components together in any allowed configurations, such as those allowed according to a rule set of the configuration facility 108R, to create modular buildings in the current project 310R window. The representations in the current project 310R window may be toggled, such as with a radio button, check box or the like. The customer may set the parameters from the current project window 310R. For example, configuration parameter #1 320R may be set and/or adjusted using a slider 324R, actually inputting a value or term 322R, and the like. In embodiments, the value for the parameter may be populated with a default setting. The default setting may be associated with a user; for example, if the user has used the system previously, the last project parameters may be used to populate the configuration parameters 202R in the current project 310R. A tolerance may be set for each of the configuration parameters such as 320aR, 320bR . . . 320nR. For example, the user may set a value but may be willing to include values above or below the indicated value of the parameter. For example, the tolerance may be indicated with a slider 328R, with a graph, with a range, deviance, standard deviation and the like. FIG. 11 shows three examples of tolerance distributions or graphs with either a narrow distribution 330R (which shows a low tolerance for variations in the parameter value), a wide distribution 334R (which shows a higher tolerance for variations in the parameter value), and a variable distribution 338R of values that would be tolerated by the customer or project. For example, in the variable distribution tolerance graph 338R, three parameters would be acceptable, with one parameter being clearly preferred. A priority 332R may be given to each parameter in the configuration.

The toolbox 312R may include tools for suggesting new components for the project, totaling a cost for the project and updating it as components and/or services are modified, validating the components in the project, estimating lead time for the project and its components, moving components around in the 3-D representation, initiating a simulation using the current project, estimating a footprint of the current project, saving a current project, and the like. A projects window 314R may list all active projects and any associated lists of components, documentation, plans, and the like. A project database 318R may list completed projects. There may also be links on the customer user interface 300R to the configuration facility 108R, optimization facility 112R, simulation facility 110R, install base 152R, CAD facility 114R, vendor facility 118R, shared calendar 124R, internal systems 120R, and the like.

In embodiments, the platform 102R may include a configuration facility 108R which may allow a user to design and configure a modular building. The configuration facility 108R may allow a user to select certain components and assemble them into a modular building according to the rule set governing the interaction between components. The configuration facility 108R may provide tools for a user to configure a modular building. The configuration facility 108R may include 2-dimensional and 3-dimensional design software. The configuration facility 108R may be programmed with a catalog of modular components and services. In an embodiment, a component may be a multifunctional building panel, such as a smart panel 20 as disclosed herein, or a roof joist and a service may be an installation service for assembling the components. The configuration facility 108R may be programmed with the attributes of each component, including, without limitation, the density, weight, dimensions, thermal properties, solar transmission, durability, performance attributes, quality, color, level of finish, life span, cost and the like. The configuration facility 108R may also be programmed with the details of each service, including, without limitation, the time for performance, cost, lead-time, level of quality and the like. The configuration facility 108R may also be programmed with information and rules regarding how the components can interact and connect, as well as with details of how the services can be deployed, such as in connection with the components. As an example, a rule regarding the components and services may be that panel-type A and panel-type B may fasten together, but that panel-type C can only be fastened to panel-type A, and that panel-type A may be installed using only a particular specified service.

In embodiments, the configuration facility 108R may provide suggestions. For example, if a user selects a component for an aspect of a building, but that component may not be used as it will not connect to the surrounding components, the configuration facility 108R may suggest an alternative component that will connect and perform a similar function. The configuration facility 108R may present certain components and services more prominently than others, or exclude certain components and services, based on the priority ranking distribution 204R. For example, if the priority ranking distribution 204R specifies that the shortest possible lead time is of the highest priority and there is little tolerance for variations in lead time, then the configuration facility 108R may not present, or may present as lower ranked options, components having a lead time longer than the desired lead time. The configuration facility 108R may provide information relating to components and services, such as pricing and availability information, and this information may be continuously or periodically updated. For example, if the priority ranking distribution 204R is adjusted, different components may be presented or if a vendor changes the price of a component, the pricing information for that component will be updated. In embodiment, the configuration facility 108R may validate a configuration to verify that the modular building is buildable.

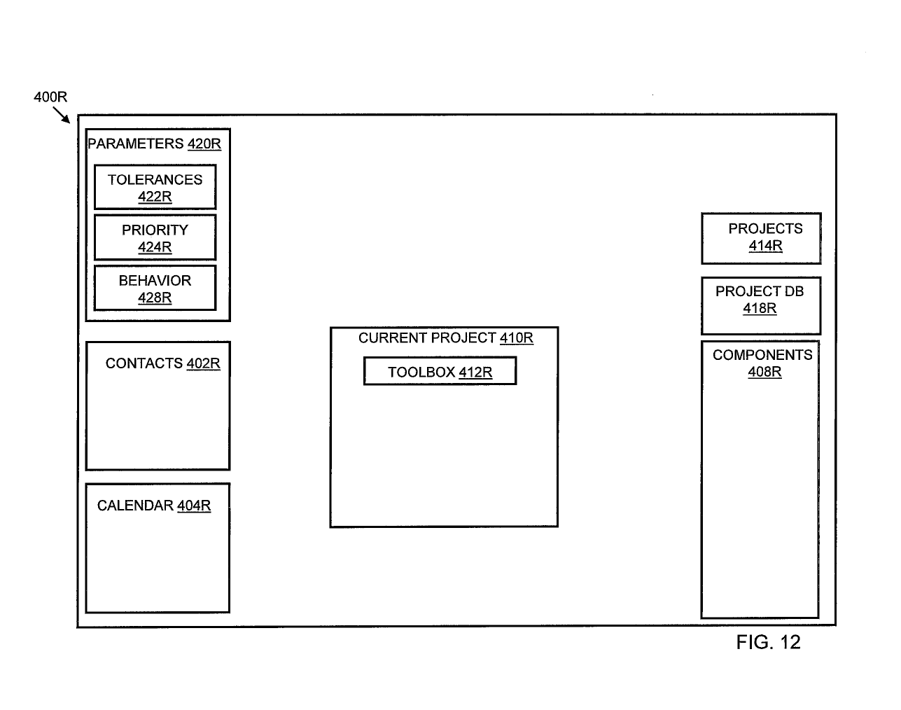

The configuration facility 108R may have a user interface 400R as depicted in FIG. 12. The configuration facility user interface 400R may be used to initiate, work on, and manage a project, interact with other users, search older projects, and the like. A contacts 402R window allows the user to maintain a list of contacts, such as architects, clients, vendors, fabricators, consultants, freighters, shippers, contractors, government personnel, and the like. From the window, the user may initiate contact, such as a chat, an e-mail, an audio call, a video call, a desktop share, an application share, a file share, and the like. A calendar 404R window may allow the user to input and/or check availability, calculate lead times, view shared calendars of other users, set the schedule for construction and tolerances for deviations, set a schedule that considers funding, so the building can be constructed in phases with payment for each phase over time, and the like.

A parameters window 420R may be used to set and adjust parameter values for the project, such as those specified using the customer interface 104R. Setting and adjusting may be done using a slider, actually inputting a value or term, and the like. A tolerance window 422R, which may be present for each parameter or all parameters, may be used to set a tolerance for each selected parameter, such as those specified using the customer interface 104R. A priority window 424R may allow the user to set priorities for each parameter, such as those specified using the customer interface 104R. A behavior modification window 428R may allow the user to indicate how willing they are to modify their parameters, tolerances, priorities and the like.

A components window 408R may list various components and services available for including in a project. The components and services may be selectable for placement in the current project window 410R. The components may be automatically selected once a parameter, tolerance, and/or priority is set. Alternatively, the user may choose to skip setting a parameter, tolerance, and/or priority and select components and/or services themselves. The current project 410R window may allow the user to select items, or view those automatically selected, from the components window 408R and either drag-and-drop them onto the current project 410R window or select them from the component window 408R and have them appear in the current project 410R window. The components may appear in the current project 410R window either as a list, a list with pictures, as 2-D pictures, or as 3-D representations. The user may be able to manipulate the components and assemble the components together in any allowed configurations, such as those allowed according to a rule set of the configuration facility 108R, to create modular buildings in the current project 410R window. In embodiments, the user may also assemble the components into configurations which may not be allowed, such as by turning off a validation function. This may be helpful in generating recommendations for modifying the components to interact in new ways. The representations in the current project 410R window may be toggled, such as with a radio button, check box or the like. The current project 410R window may include a toolbox 412R. The toolbox 412R may include tools for suggesting new components for the project, totaling a cost for the project and updating it as components and/or services are modified, validating the components in the project, estimating lead time for the project and its components, moving components around in the 3-D representation, initiating a simulation using the current project, estimating a footprint of the current project, saving a current project, and the like. A projects window 414R may list all active projects and any associated lists of components, documentation, plans, and the like. A project database 418R may list completed projects. There may also be links on the configuration facility user interface 400R to the optimization facility 112R, simulation facility 110R, install base 152R, CAD facility 114R, vendor facility 118R, shared calendar 124R, internal systems 120R, and the like.

In embodiments, the platform 102R may include a simulation facility 110R which may generate predicts regarding various parameters of and/or related to the modular building. In an embodiment, the simulation facility 110R may predict the energy and cost profiles for a modular building, performance metrics and the like. In embodiments, the simulation facility 110R may consider various parameters of the environment in which the building will be placed, as well as parameters of the building itself, including the building as a whole, as well as its component parts. In embodiments, parameters considered by the simulation facility 110R may include parameters not determined by the design of the modular building, including, without limitation, the cost of energy, projected inflation rate, projected interest rates, projected appreciation rates, details of the location at which the modular building will be located, latitude, longitude, elevation, climate, weather patterns, temperature, precipitation, humidity, wind, cloud cover, air quality, and solar radiation, typical meteorological year data and the like.

In embodiments, the simulation facility may also consider parameters which may also be affected by the design of the modular building, including, without limitation, life span, energy use, isolation, daylighting, thermal comfort, type and amount of mass, type and size of window overhangs, type and amount of ventilation, type and amount of interior shading, type and amount of exterior shading, cost effectiveness, comfort, orientation, type and amount glass, type and amount of glass coatings, type and amount of glass glazing, inclusion and details of clerestory, inclusion, size and details of store front glass, inclusion, amount and type of thermal mass, fenestration pattern, type and amount of insulation, type and amount of wall insulation, type and amount of roof insulation, snow load, occupancy, ambient interior temperature, interior humidity, air quality, ambient light intensity, reflectivity of light, absorption of heat, ventilation, operational characteristics of a component such as power usage and the like, phantom loads, power use versus need, likelihood and effect of building malfunctions such as heat leaks, plumbing leaks and the like, network state information, security related parameters, insulative properties, water management, grey water management, lighting, acoustics, sound transmission, sound reflectivity, inclusion and characteristics of a living roof, lead-time, construction schedule, inclusion, type and details of solar panels, orientation and tilt of solar panels, inclusion, type and details of solar heating systems, inclusion, type and details of solar water heating systems, inclusion, type and details of biodiesel systems, inclusion, type and details of fuel cell systems, inclusion, type and details of water recycling and grey water systems and the like, inclusion, type and details of photo-reactive materials, such as in windows, inclusion, type and details of wind power generation systems and the like. The simulation facility 110R may also consider returning power generated by the modular building to the grid.

In embodiments, the parameters may be input parameters used to determine other values, in whole or in part. For example, cloud cover typical of the site may be used as an input parameter to help determine the daylighting profile for the modular building. In another example, the life span of the building may be used as an input parameter to help determine the annualized cost of an aspect of the building. In embodiments, these parameters may be output parameters determined or adjusted by the simulation facility 110R. For example, the simulation facility 110R may determine the expected heating and cooling costs based at least in part on data relating to temperature and wind patterns. In another example, the life span of the building may be determined based at least in part on the quality of the materials and the weather patterns at the location.

In an embodiment, the simulation facility 110R may consider the fact that the building will be constructed in phases, such as due to funding constraints. The simulation facility 110R can generate simulation and predictions for each phase of construction. In embodiments, the simulation facility 110R may provide suggestions for improving or altering a simulation. The simulation facility 110R may include third party software, off-the-shelf and/or open source software, such as environmental software. The simulation facility 110R may include customized software and/or proprietary software, such as environmental software. In embodiments, the simulation facility 110R may form part of the optimization facility 112R.

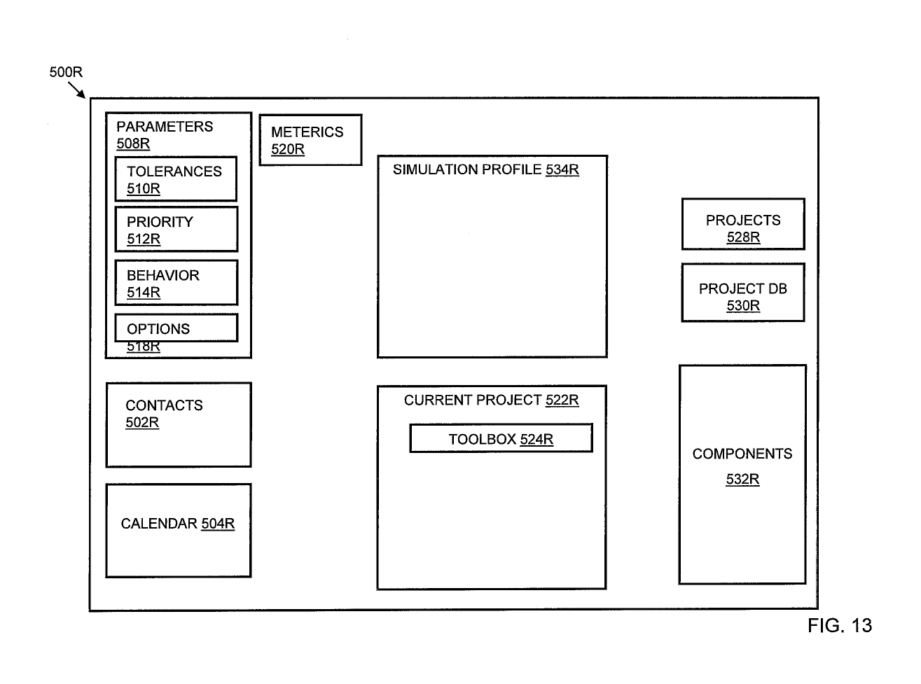

The simulation facility 110R may have a user interface 500R as depicted in FIG. 13. The simulation facility user interface 500R may be used to analyze the energy use, predict performance, determine a cost profile, and the like of a modular building based. A contacts 502R window allows the user to maintain a list of contacts, such as architects, clients, vendors, fabricators, consultants, freighters, shippers, contractors, government personnel, and the like. From the window, the user may initiate contact, such as a chat, an e-mail, an audio call, a video call, a desktop share, an application share, a file share, and the like. A calendar 504R window may allow the user to input/check availability, calculate lead times, view shared calendars of other users, set the schedule for construction and tolerances for deviations, set a schedule that considers funding, so the building can be constructed in phases with payment for each phase over time, and the like.

A parameters window 508R may be used to set and adjust parameter values for the project to be simulated, such as those specified using the customer interface 104R. Setting and adjusting may be done using a slider, actually inputting a value or term, and the like. A tolerance window 510R, which may be present for each parameter or all parameters, may be used to set a tolerance for each selected parameter, such as those specified using the customer interface 104R. A priority window 512R may allow the user to set priorities for each parameter, such as those specified using the customer interface 104R. A behavior modification window 514R may allow the user to indicate how willing they are to modify their parameters, tolerances, priorities and the like.

An options 518R window may enable the user to limit which options to include in the simulation, as well as whether there are any additional data to consider in the simulation, such as location, climate, if the project is to be completed in phases, if the project is to be simulated in phases, and the like. A metrics window 520R may enable the user to select which metric the user would like to be presented in the simulation. The current project window 522R may display the current project components and/or services shown as a list, a list with pictures, as 2-D pictures, or as 3-D representations or some combination thereof. As the simulation proceeds, the current project window 522R may display the modular building with indications where the modular building may be optimized. The simulation facility 110R may graphically depict the energy profile of the building. A toolbox 524R may enable the user to interact with the simulation to stop it at a certain point, submit the project for optimization, to include feedback from other constructed projects in the simulation, and the like. A projects window 528R may list all active projects and any associated lists of components, documentation, plans, and the like. A project database 530R may list completed projects. A components window 532R may list various components and services available for including in a project and may highlight those already included in the project. The components and services may be selectable for placement in the current project window 522R. The components may be automatically selected once a parameter, tolerance, and/or priority is set. A simulation profile window 534R may graphically show a simulated profile of the modular building as it is generated during the energy profile. There may also be links on the simulation facility user interface 500R to the optimization facility 112R, configuration facility 108R, install base 152R, and the like.

In embodiments, the platform 102R may include an optimization facility 112R which may optimize a modular building in consideration of a priority ranking distribution 204R. In embodiments, the optimization facility 112R may consider various parameters of the environment in which the building will be placed, as well as parameters of the building itself, including the building as a whole, as well as its component parts. The optimization facility 112R may generate performance predictions and may provide suggestions and recommendations for changing parameters of the building or locating to a different location.

In embodiments, parameters considered by the optimization facility 112R may include parameters not determined by the design of the modular building, including, without limitation, the cost of energy, projected inflation rate, projected interest rates, projected appreciation rates, details of the location at which the modular building will be located, latitude, longitude, elevation, climate, weather patterns, temperature, precipitation, humidity, wind, cloud cover, air quality, and solar radiation, typical meteorological year data and the like. In embodiments, the optimization facility 112R may also consider parameters which may also be affected by the design of the modular building, including, without limitation, life span, energy use, isolation, daylighting, thermal comfort, type and amount of mass, type and size of window overhangs, type and amount of ventilation, type and amount of interior shading, type and amount of exterior shading, cost effectiveness, comfort, orientation, type and amount glass, type and amount of glass coatings, type and amount of glass glazing, inclusion and details of clerestory, inclusion, size and details of store front glass, inclusion, amount and type of thermal mass, fenestration pattern, type and amount of insulation, type and amount of wall insulation, type and amount of roof insulation, snow load, occupancy, ambient interior temperature, interior humidity, air quality, ambient light intensity, reflectivity of light, absorption of heat, ventilation, operational characteristics of a component such as power usage and the like, phantom loads, power use versus need, likelihood and effect of building malfunctions such as heat leaks, plumbing leaks and the like, network state information, security related parameters, insulative properties, water management, grey water management, lighting, acoustics, sound transmission, sound reflectivity, inclusion and characteristics of a living roof, lead-time, construction schedule, inclusion, type and details of solar panels, orientation and tilt of solar panels, inclusion, type and details of solar heating systems, inclusion, type and details of solar water heating systems, inclusion, type and details of biodiesel systems, inclusion, type and details of fuel cell systems, inclusion, type and details of water recycling and grey water systems and the like, inclusion, type and details of photo-reactive materials, such as in windows, inclusion, type and details of wind power generation systems and the like. The optimization facility may also consider returning power generated by the modular building to the grid.

The optimization facility 112R may consider the mix of passive and active controls of the modular building. For example, a passive control may be a means of affecting a modular building that does not consume power, such as the selection of materials with high thermal conductance, a particular pattern of windows, or the length of the window overhangs and the like. For example, an active control may be a means of affecting a modular building that consumes power, such as a powered ventilation system, ceiling fan and the like. In embodiments, the optimization facility 112R may consider the fact that the building will be constructed in phases and conduct an optimization for each phase. The overall optimization may optimize what should be completed in each phase to achieve the objectives in light of the priority ranking distribution 204R in each phase and overall.

The optimization facility 112R may consider feedback from the installed base of modular buildings. In such a manner the optimization facility 112R may learn from real world feedback. For example, the optimization facility 112R may obtain data regarding the accuracy of its past optimizations, as well as updated data regarding conditions at the locations in the install base, geography, configuration and the like, as well as the network as a whole. In embodiments, the optimization facility 112R may form part of the simulation facility 110R. In embodiments, the optimization facility 112R may utilize elimination parametrics. In embodiments, the optimization facility 112R may employ an iterative process. In embodiments, the optimization facility 112R may consider outside factors to eliminate or determine the values of certain parameters. For example, the optimization facility 112R may remove from consideration any components outside the desired lead-time and tolerance range for lead-time variation.

In embodiments, a modular building's design configuration, including material choices, orientation, ventilation, and the like, may be selected using the configuration facility 108R because it best matches at least one of the requirements and/or tolerances selected by the user for modeling in the configuration facility interface. However, while a selected design configuration may be the best choice given a single selected parameter or subset of parameters or for certain aspects of the priority ranking distribution 204R, it may not be the optimal choice given the totality of the parameters. The optimization facility 112R may perform a parametric optimization process 600R that models the selected parameters and/or tolerances in order to determine an optimal design configuration or configurations. For example, if the same energy-efficiency may be achieved with a configuration of thermal mass and inexpensive windows as with a configuration with no thermal mass and expensive windows, the optimization process 600R will choose the less expensive of the two configurations if cost is a consideration per the priority ranking distribution 204R.

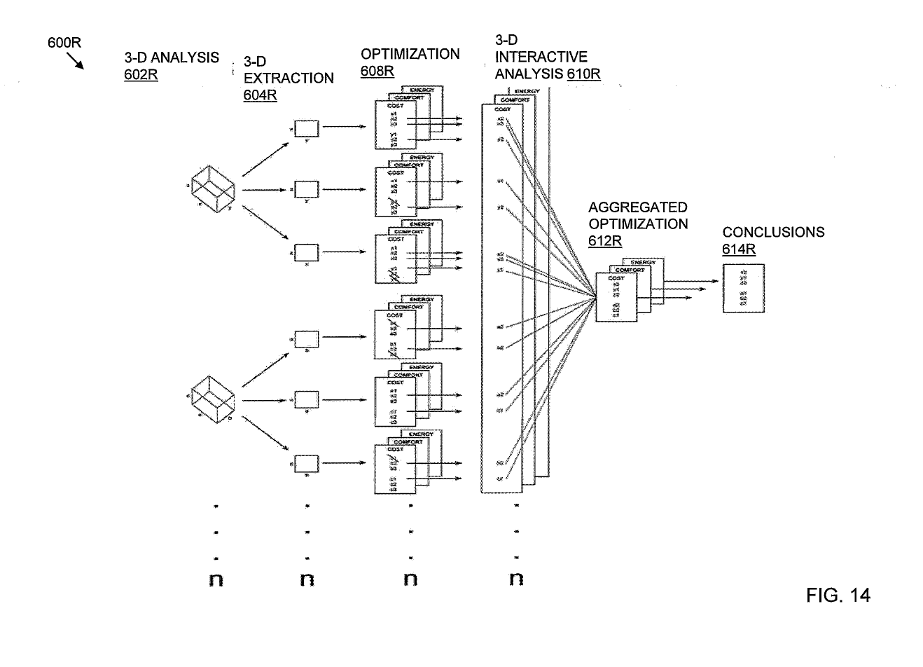

Referring to FIG. 14, the optimization process 600R may differ from a traditional energy analysis in that multi-dimensional matrices covering potentially thousands of scenarios may be utilized in the design configuration optimization process 600R. The optimization process 600R may result in determination of the optimal cost-benefit balance of any structural or material energy efficiency measure. In other embodiments, energy may not be considered or may be of less importance. The disclosure herein presents several particular embodiments of the optimization process 600R; however, the optimization process 600R may be applied to any number of parameters of any type. The benefit or cost, in terms of energy use, construction cost and occupant comfort, of any individual alternative design configuration may be incremental, so identifying the point of diminishing returns enables a determination of the best options to maximize the overall return. For example, though energy use may be a primary metric in determining a design configuration, there are practical limits to the constructability of energy efficiency solutions.

The optimization process 600R may employ a deterministic, quantitative multi-criteria decision model (MCDM) algorithm to weigh the relative importance of three metrics used to define the optimal configuration for the modular building: energy efficiency, cost-effectiveness and occupant comfort. Cost-effectiveness may be described as both the reductions in the first cost and operational cost through better energy efficiency, and also the potential increased costs of an improved configuration or material choice. The sum of these costs or cost savings is considered the cost-effectiveness for choosing a particular design configuration with a real impact on overall construction cost and a real impact on energy use. While cost-effectiveness may not be a priority in and of itself, since it may be possible to continue to see incremental energy benefits beyond reasonable constructability limits, it may be used as a primary variable because it is a proxy for energy efficiency without diminishing returns. Occupant comfort may be represented by degree-hours of mean radiant temperature (average surface temperature) above a certain temperature set point. By considering cost and comfort, in addition to energy use, better decisions can be made regarding a particular design configuration.

The optimization process 600R may include modeling of each design configuration to quantify the energy, cost and comfort values of each configuration. In this particular embodiment, several parameters may be varied, such as orientation, wall insulation, roof insulation, thermal mass, shading (such as roof overhangs), glass—clerestory windows, glass—storefront windows, glass—all other windows, ventilation area, and the like. To find the highest-performing structure for a balance of all three criteria among all possible combinations of each option for each of the nine parameters, the optimization process 600R may search a 9-dimensional parameter space and measure the success of each by the three performance criteria, that is, energy efficiency, cost-effectiveness and occupant comfort. In other embodiments, the optimization process 600R may consider a parameter space with fewer, more or the same number of parameters. The optimization process 600R may be embodied as computer executable code that, when executing on one or more computing devices, performs the steps of the process, such that a very large number of variations may be modeled and evaluated in a relatively short time. For example, each of the above parameters may include a number of variations, such as levels of thermal mass, glazing types, roof overhang dimensions, and the like. All possible combinations of all of the parameters may be modeled or simulated by the simulator and evaluated by the optimization facility 112R.

Continuing to refer to FIG. 14, as it may only be possible to graphically visualize three dimensions at a time, an initial series of 3-D analyses 602R may compare the above parameters three at a time, and show how they score in terms of energy, cost and comfort. For example, one 3-D analysis 602R may involve wall insulation versus roof overhang length versus clerestory window type. For each 3-D analysis 602R, three 2-D graphs may be extracted during a 2-D extraction 604R step to provide clearer access to the results. The 2-D graphs may illustrate how just two of the parameters, for instance, wall insulation versus roof overhang length in the above example, may contribute to overall performance in terms of energy, cost and comfort. This initial series of 3-D analyses 602R, 2-D extraction 604R, and optimizations 608R involving three parameters at a time essentially comprise a mini-optimization. By first performing these mini-optimizations, the larger optimization process 600R involving all nine parameters, concluding with the steps of a multi-parametric, or n-D, interactive analysis 610R and aggregated optimization 612R, may be computationally facilitated.

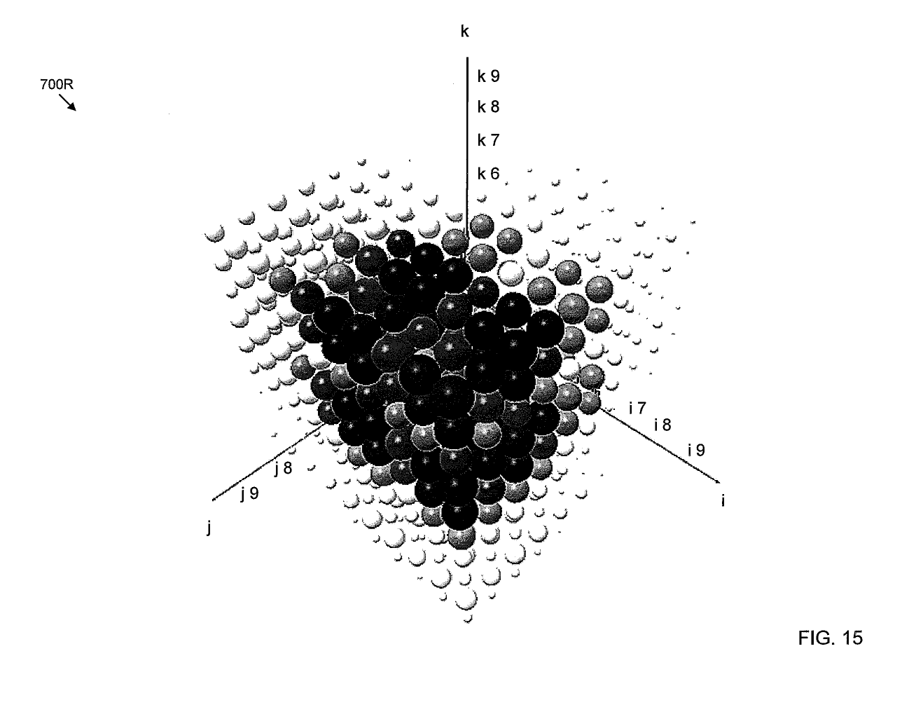

Referring now to FIG. 15, an example of a 3-D analysis is shown. In this example, energy use is plotted on a 3-dimensional parametric graph, where the larger and darker icons represent lower energy states. Each icon is a result from a single simulation of one configuration consisting of one option for each of the 3 parameters, in this case glazing type for the three types of windows of the envelope. Energy efficiency improves, as expected, up to the limits of the parameters specified. The model shown in FIG. 15 does not identify which option is the best, but it does illustrate possible combinations of parameters, in this case window types, that result in higher energy efficiency as indicated by the darker icons. By limiting the number of parameters modeled, the results may be limited to the most feasible options. The 3-D analysis 602R enables visual identification of the point of diminishing returns, where the incremental gains in efficiency that occur from selecting better materials, become so small that they no longer make sense. In this example, it is apparent that, at least from an energy use standpoint, many solutions make sense.

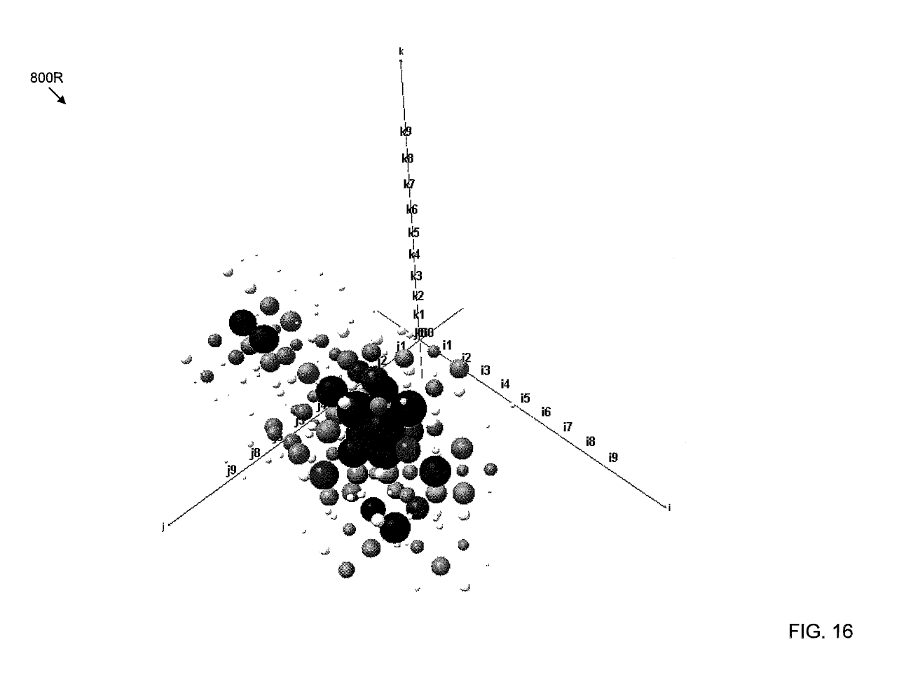

From a cost effectiveness perspective, a best case set of glazing specifications becomes apparent in FIG. 16. FIG. 16 depicts a plot of overall cost-effectiveness charting the same 3-dimensional parametric set plotted in FIG. 15. FIG. 16 is the result of an optimization 608R. In the optimization 608R shown in FIG. 14, the primary variable chosen was cost. For example, cost may balance the addition of extra insulation, superior windows or other factors against the cost of adding photovoltaic panels to simply generate more energy for mechanical cooling. Extra insulation, window performance, and the like may be favored until they reach outlandish proportions due to diminishing returns, at which point photovoltaic panels may be favored. In FIG. 16, larger, darker icons represent the best cost-effectiveness. The large dark icon in the middle represents the best case simulation of one configuration consisting of one glazing type for each of the three types of windows of the envelope. In this case, the “best” configuration is a first glazing type in the front windows, a second glazing type in the clerestory windows, and the first glazing type in the lower windows. While the windows in this configuration may not be the best windows money can buy, they may be the best solutions given the parameters specified.

Multiple 3-dimensional analyses 602R may be performed initially to narrow the search, and whole categories of unrealistic or non-beneficial strategies may be eliminated, while the best ones may be selected for the final n-dimensional analysis. The 3-dimensional parameter combinations may be chosen for those parameters that may have synergistic relationships. For example, a structure with high thermal mass and poor-quality glazing may perform as well as a structure with little thermal mass and high-performance glazing.

To determine the optimal combination, all possible synergistic combinations may be quantified. The top group of parameter definitions may be chosen from each of the 3-D analyses 602R, 2-D extractions 604R, and optimizations 608R to carry forward into the n-D interactive analysis 610R. For example, in FIG. 14, 2 sample 3-D analyses 602R are shown from n possible analyses. In the first analysis, parameters x, y, and z are the subject of the analysis. The 2-D extraction 604R results in pairwise graphs of x and y, z and y, and z and x, to provide clearer access to the results of the 3-D analysis 602R. In the optimization 608R, one of three metrics, cost, energy efficiency or occupant comfort, is considered in connection with each of the pairwise parameters to identify the best options for each parameter. Each such option may be a first optimal value. In this example, cost is the metric being considered. For example, in the x-y pairing, the best options with respect to cost were x2, x3 and y2. In the z-y pairing, the best options were x1 and y2. Finally, in the z-x pairing, the best options were x2, x3, and y1. All of these options are considered in the n-D interactive analysis 610R, along with the a, b, and c options identified from the second set of optimizations 608R shown in FIG. 14 based on the 3-D analysis 602R of a, b, and c parameters.

The multi-parametric, or n-D, interactive analysis 610R models or simulates all the “best” options for all of the parameters identified in a plurality of 3-D analyses 602R, 2-D extractions 604R, and optimizations 608R to arrive at a set of options for aggregated optimization 612R. Each such option may be a second optimal value. For example, the multi-parametric analysis 610R may involve options for 9 parameters. The optimization 612R step re-considers the best options in terms of cost, energy efficiency, or occupant comfort to select an optimally-suitable configuration. In this example, cost is the metric considered in the aggregated optimization 612R. Each metric may be weighted by a factor that may be considered to best meet the goals and priorities of the potential end-user. Though, in this embodiment, the algorithm for the optimization 612R is not linear, the calculation can be generalized as: (We*EnergyValue)+(Wc*CostValue)+(Wm*ComfortValue)=Ranking, where: We, c, m are weighting factors for each performance metric, and Energy, Cost and Comfort are values for each metric. Using this calculation, it is possible to parse through a large amount of data very quickly and create quantitative comparisons. The conclusions 614R for the optimization 612R are an optimized option for each parameter. Though final design decisions may also include the qualitative filters that only the designer and end user can provide, these quantitative filters may inform those decisions by narrowing the range of choices to a manageable and relevant few, and by defining the costs and benefits of each decision.

While the optimization process 600R may be used for de novo design configuration, the process 600R may also be employed post-construction. Sensors mounted on an existing structure may indicate how the structure is performing in the field. For example, sensors may indicate exactly how much light really is reaching an interior space, how high the interior temperature reaches, if there is adequate ventilation, and the like. The sensor data may be delivered back to the optimization facility to determine if there are post-construction changes that could be made to optimize the existing design. The sensor data may also be used to update certain assumptions in the optimization algorithms.

For example, the optimization process 600R may be applied to a proposed structure in Honolulu, Oahu, Hawai'i. Of the various climates in Hawai'i, Honolulu may be the most extreme cooling climate. The optimization 608R applied to a structure in this climate predicts that the optimal structure configurations may generally include higher insulation levels and better shading. Mass may also be beneficial in reducing cooling loads slightly and may improve occupant comfort for a reasonable return on cost. Shading design and glazing type may strongly affect the energy use in Honolulu. Orientation may not strongly affect energy use on a properly-shaded baseline facility. Glazing type may be critical to energy performance, and glazing type may be by far the most important place to invest in quality materials. Good solar control glazing may be important. Baseline shading design, such as a 3 ft upper roof eave overhang, may be sufficient for most configurations, but for optimal performance, an additional 1 foot overhang may still offer a positive cost-effectiveness. Insulation and mass may offer some benefit in many of the top optimal configurations, though these elements do appear as critical to good performance. The analysis shows roof insulation to be the most important place to enhance baseline configuration due mainly to controlling conduction of solar gains. Mass primarily offers comfort benefits by reducing peak temperature swings.

Proper ventilation may be critical to optimizing performance. Though in this particular embodiment the model indicates that peak loads cannot be naturally ventilated in Honolulu due to high daytime temperatures, swing period venting may produce significant benefits. Of the climates in Hawaii, Honolulu may require the highest air change rate, due to the lower temperature difference between low outdoor temperatures and comfortable indoor temperatures during venting periods. Ventilation may also act to enhance occupant comfort and increase internal thermostat set points, thereby also reducing overall cooling loads.

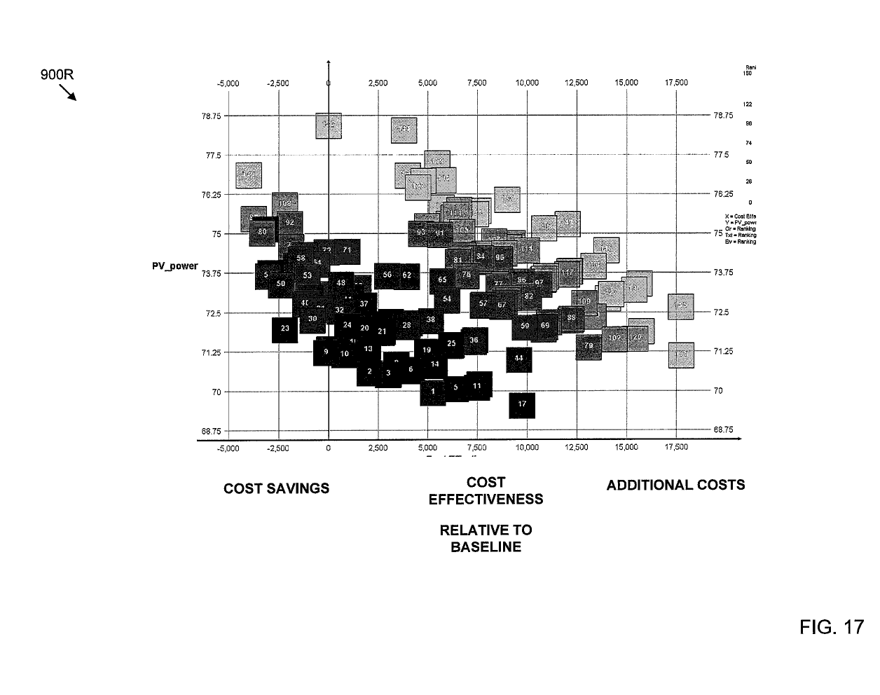

After reviewing the impact of each configuration separately, the multi-variable parametric analysis in the aggregated optimization 612R step reveals some interesting relationships between the variables. The data from the final set of simulations in a 9-d matrix of all of the top combinations of options from the mini-optimization analysis (the first three steps of the optimization process 600R) is shown in FIG. 17 as a simple scatter chart plotting energy use against cost-effectiveness (defined as the total construction cost increase from baseline, less the cost savings due to a reduction in the size of the required PV plant). The analysis of the top ten configurations for Honolulu, as depicted in FIG. 17, reveals that many of the “best” strategies for roof insulation, ventilation area and glazing type appear in all of the top configurations, but certain combinations provide the best performance and cost-effectiveness. What truly impacts the performance is the relationship between wall/roof insulation, thermal mass and the size of the roof overhangs.

In FIG. 17, the color-scale and values shown in the icons both represent the overall ranking of the configuration by the optimization process 600R, with darker icons with lower numbers being the better options and lighter icons with higher numbers being the least desirable options. The ideal structure would have the least cost (or best overall cost savings), and the lowest energy use (lower-left of the chart). As mentioned earlier, even if low cost is not a priority by itself, it is an excellent proxy for energy efficiency without diminishing returns, helping the user determine ‘how good is good enough.’

Since energy efficiency measures generally come with an associated cost, a trend appears where lower cost configurations generally use more energy. In other words, a structure made of lower-quality, cheaper products leads to higher energy use to get a comfortable, high performance, energy-neutral facility. In this case, higher energy use also means that the size of the photovoltaic system may need to be increased to accommodate the additional loads. Reducing energy use, therefore leads to a direct reduction in construction costs due to reduced cost of the photovoltaic plant. By considering this as part of the first-cost equation, it is apparent that there is a natural balance between expenditures for energy efficiency measures, and savings in power plant cost. Finding that balance is part of the optimization process 600R. Generally, more successful configurations will occur toward the lower left corner of the chart, where there is good cost-efficiency (balance between construction cost and photovoltaic plant cost), and low energy use. The most optimal configuration in the chart below is not the lowest energy use, but it is the best value for sufficiently low energy use. Finally, the icons labeled 1, 2, adjacent to 9, adjacent to 52, and adjacent to 80 represent the progression of sequential facility improvements between baseline and optimum in the following order: natural ventilation, enhanced natural ventilation, shading, insulation, mass. The unventilated baseline configuration shows up at the top of the chart (configuration #142). The analysis shows that it is possible to significantly lower overall energy use with a reasonable investment in energy efficiency measures. The top configuration for this particular embodiment is circled and labeled #1. This optimized high value design includes an orientation of +/−60 deg of North, roof insulation of R 35, wall insulation of R 12, additional internal mass of 1″ SHEETROCK (or equivalent), roof overhangs of 4 ft total upper roof eaves (additional 1 foot beyond baseline), and extended shading devices, SOLARBAN80 in 1″ IGU with Argon glazing (or similar U-value, SHGC, Tvis) glass, and a ventilation area of at least 75 sq.ft. of free flow area. In this embodiment, it was determined that the annual energy use of the baseline structure would be 78.4 GJ or 21,800 kWh, while the annual energy use of configuration #1 is 69.9 GJ or 19,400 kWh, or 1,508 sq ft of photovoltaic panels, which represents an energy savings of 11.1% over baseline. Further, the photovoltaic installation savings may offset the additional construction costs.

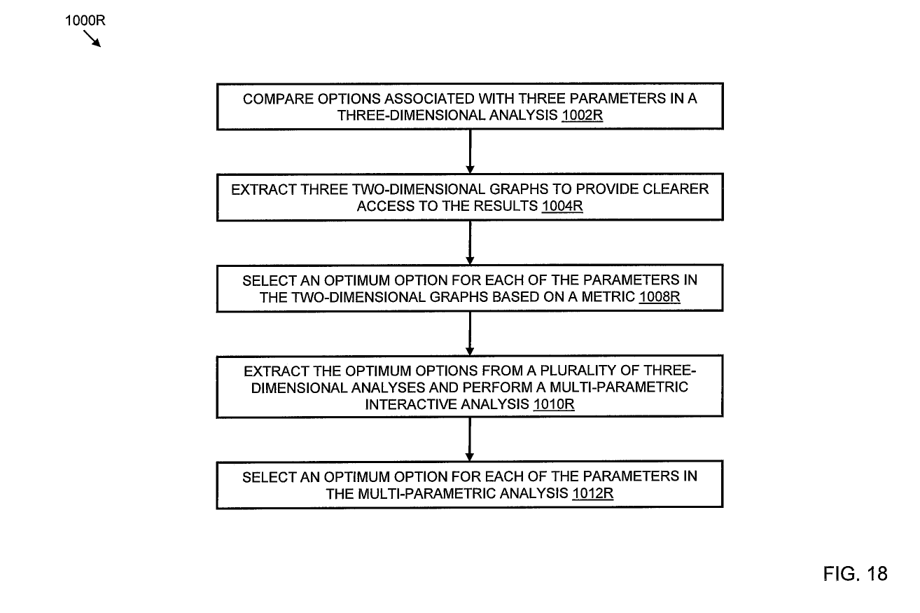

Referring to FIG. 18, the optimization process 600R may be embodied as an executable program stored on a computer-readable storage medium. In an embodiment, the program may instruct a processor to perform the following steps: comparing options associated with three parameters in a three-dimensional analysis 1002R, wherein the parameters comprise at least three of orientation, wall insulation, roof insulation, thermal mass, shading (roof overhangs), glass—clerestory windows, glass—storefront windows, glass—all other windows, and ventilation area; extracting three two-dimensional graphs to provide clearer access to the results 1004R, wherein the graphs comprise pairwise comparisons of the three parameters; selecting an optimum option for each of the parameters in the two-dimensional graphs based on a metric 1008R, wherein the metric comprises at least one of cost, comfort, and energy efficiency; extracting the optimum options from a plurality of three-dimensional analyses and perform a multi-parametric interactive analysis 1010R; and selecting an optimum option for each of the parameters in the multi-parametric analysis 1012R. The multi-parametric analysis may include options for more or less than three parameters. The multi-parametric analysis may include options for at least nine parameters. The options considered for each parameter may be limited by an associated tolerance.

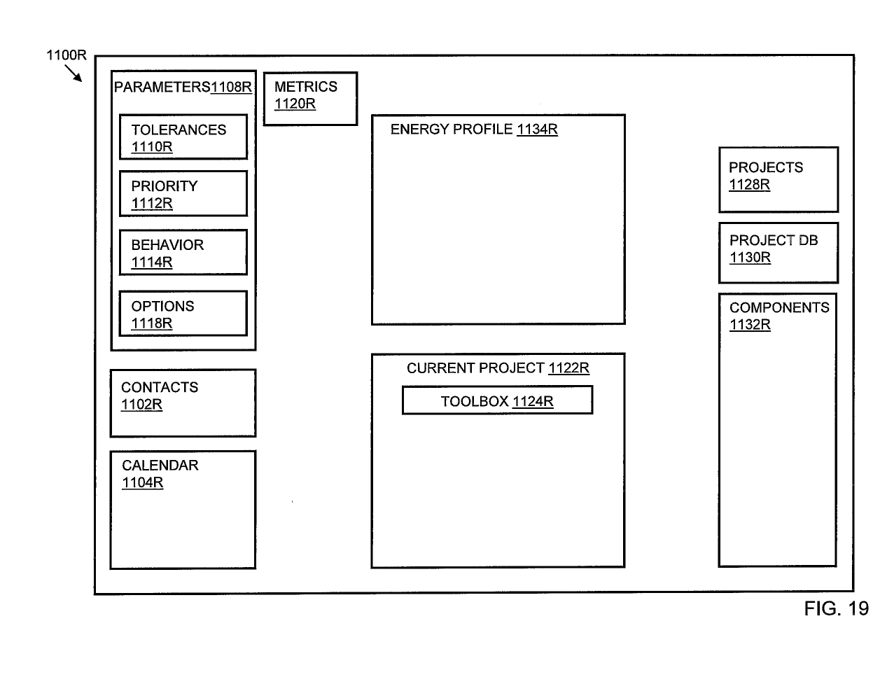

Referring to FIG. 19, a user interface 1100R for the optimization facility 112R is shown. The optimization facility user interface 1100R may be used to optimize a project, provide performance predictions, interact with other users, search and view older projects, receive feedback on existing projects, and the like. A contacts 1102R window allows the user to maintain a list of contacts, such as architects, clients, vendors, fabricators, consultants, freighters, shippers, contractors, government personnel, and the like. From the window, the user may initiate contact, such as a chat, an e-mail, an audio call, a video call, a desktop share, an application share, a file share, and the like. A calendar 1104R window may allow the user to input/check availability, calculate lead times, view shared calendars of other users, set the schedule for construction and tolerances for deviations, set a schedule that considers funding, so the building can be constructed in phases with payment for each phase over time, and the like.

A parameters window 1108R may be used to set and adjust parameter values for the project, such as those specified using the customer interface 104R. Setting and adjusting may be done using a slider, actually inputting a value or term, and the like. A tolerance window 1110R, which may be present for each parameter or all parameters, may be used to set a tolerance for each selected parameter, such as those specified using the customer interface 104R. A priority window 1112R may allow the user to set priorities for each parameter, such as those specified using the customer interface 104R. A behavior modification window 1114R may allow the user to indicate how willing they are to modify their parameters, tolerances, priorities and the like.

An options 1118R window may enable the user to limit which options to include in the parametric optimization, as well as whether there are any additional data to consider in the optimization, if the project is to be completed in phases, if the project is to be optimized in phases, and the like. A metrics window 1120R may enable the user to select which metric to include in the optimization. The current project window 1122R may display the current project components and/or services shown as a list, a list with pictures, as 2-D pictures, or as 3-D representations or some combination thereof. As the optimization proceeds the current project window 1122R may display the optimized components and/or services either in the same window, in a split screen, in replacement on the original project, in a new window, and the like. A toolbox 1124R may enable the user to interact with the optimization to stop it at a certain point, select an optimization method (such as elimination parametrics, and the like) to pick and choose which optimizations to keep, to determine a pricing for the optimized components and/or services, to modify the project and submit it for additional optimization, to include feedback from other constructed projects in the optimization, and the like. A projects window 1128R may list all active projects and any associated lists of components, documentation, plans, and the like. A project database 1130R may list completed projects.

A components window 1132R may list various components and services available for including in a project and may highlight those already included in the project. The components and services may be selectable for placement in the current project window 1122R. The components may be automatically selected once a parameter, tolerance, and/or priority is set. An energy profile window 1134R may graphically show the energy profile of the modular building, or various possible selections of components for the modular building, based on the optimization. In embodiments, the energy profile may be replaced with any other profile relating to the parameters, such as the parameters include in the priority ranking distribution 204R. There may also be links on the optimization facility user interface 1100R to the configuration facility, simulation facility, and the like.

In embodiments, the platform 102R may include a CAD facility 114R which may assist with designing, visualizing, viewing and/or modeling a modular building. In other embodiments, the CAD facility 114R may be absent or not used. In embodiments, the CAD facility 114R may include dynamic CAD software, 3-dimensional and 2-dimensional modeling software. In embodiments, the CAD facility 114R may accept as an input the configuration, layout, materials and the like, possibly from the configuration facility 108R, and generate a 3-dimensional and/or 2-dimensional model based on the inputs. In another embodiment, the CAD facility 114R may provide input to and receive output from the simulation facility 110R and/or optimization facility 112R. For example, the CAD facility 114R can batch a 3-dimensional model and parametric data into the simulation facility 110R and/or optimization facility 112R to determine base performance metrics, an optimization or the like. In embodiments, a human may review the 3-dimensional and/or 2-dimensional models and drawings to verify that an acceptable result has been produced.

In embodiments, the platform 102R may include a vendor facility 118R which may facilitate collecting and storing information and data obtained from and/or pertaining to vendors, suppliers, fabricators, contractors and the like, and may provide data and information to vendors, suppliers, fabricators, contractors and the like. In embodiments, the vendor facility 118R may act as a repository for information and data relating to vendors, suppliers, fabricators, contractors and the like, such as information and data relating to the pricing and availability of components, materials and services. By storing the information and data, users do not need to request the information and data from vendors suppliers, fabricators, contractors and the like each time it is needed.

In embodiments, the vendor facility 118R may facilitate interaction, such as live interactions, among suppliers, fabricators, contractors and the like and other users of the platform 102R. Such interaction may result in a vendor network. The vendor facility 118R may facilitate conducting a bid process for projects, components and/or services, creating a competitive market. The vendor facility 118R may facilitate bidding on completing projects, such as the construction of a modular building, providing components and parts, such as for the construction of a modular building and providing services, such as for the construction of a modular building. FIG. 9 shows the vendor facility 118R as being internal to the platform 102R; however, in embodiments, the vendor facility 118R, along with any other engine, facility or aspect of the platform, may be external for the platform 102R or internal to the platform 102R.

In embodiments, the vendor facility 118R may collect, store and provide data relating to the availability and/or lead time for particular components and services, or for overall projects. In embodiments, the vendor facility 118R may interface with the shared calendar 124R in order to determine the real time, updated availability and/or lead time for particular components and services, or for overall projects. For example, the vendor facility 118R may allow a vendor to enter, and then later provide to a user, a schedule for the availability of a particular component which may include that in July and August the lead time is 5 weeks, but during the rest of the year the lead time is only 3 weeks. If the vendor facility 118R cannot interface with the shared calendar, the vendor facility 118R may provide simple lead times that were previously stored in a repository of the vendor facility 118R.

In embodiments, the vendor facility 118R may interface with the shared calendar 124R in order to determine the real time, updated pricing information for particular components and services, or for overall projects. The pricing may vary with the time of year and availability. For example, the vendor facility 118R may allow a vendor to enter, and then later provide to a user, information relating to the pricing of a particular component, which may include that in July and August the price is $100 per unit, but during the rest of the year the price is only $80 per unit. The vendor facility 118R may also be used to distinguish different prices and availability for different versions of a component. For example, the degree of finish of a component may be varied so that a component that is not entirely finished (for example, it is missing interior facing drywall) could be less expensive and available sooner than the finished component. If the vendor facility 118R cannot interface with the shared calendar 124R, the vendor facility 118R may provide pricing information that was previously stored in a repository of the vendor facility 118R.

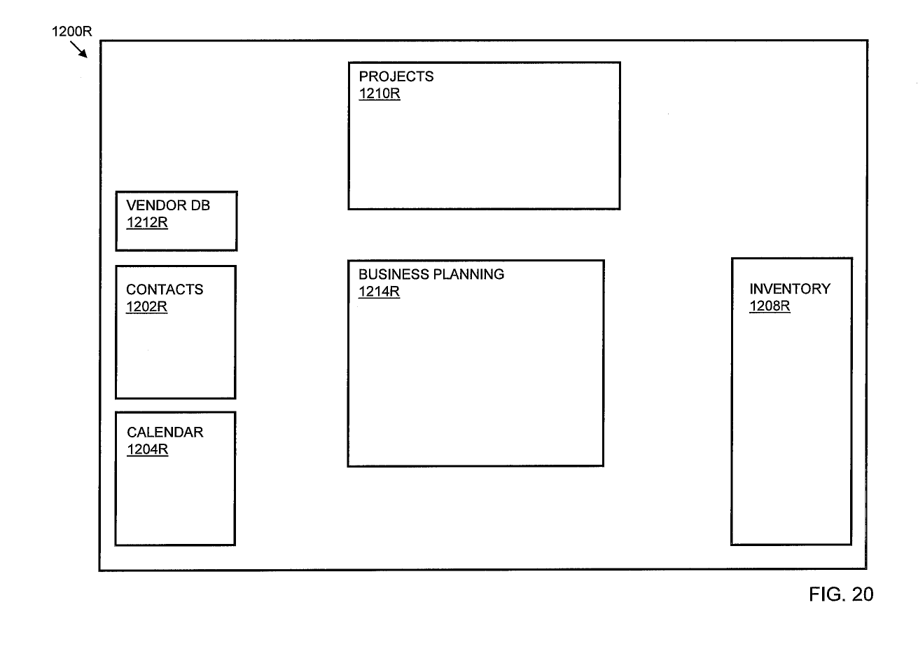

Referring now to FIG. 20, a vendor user interface 1200R for the vendor facility is shown. A contacts 1202R window allows the vendor to maintain a list of contacts, such as architects, clients, other vendors, fabricators, consultants, freighters, shippers, contractors, government personnel, and the like. From the window, the vendor may initiate contact, such as a chat, an e-mail, an audio call, a video call, a desktop share, an application share, a file share, and the like. A calendar 1204R window may allow the vendor to input/check availability, calculate lead times, view shared calendars of other users, and the like. An inventory window 1208R may allow the vendor to provide, view, or select component availability, pricing, lead-time, length to market, and the like. A projects window 1210R may allow the vendor to keep a list of open and upcoming projects and any specific needs relating to the project, such as associated lists of components, documentation, plans, and the like. The project may include one or more modular buildings. Other users, such as architects, other vendors, fabricators, consultants, freighters, shippers, contractors, government personnel, may view the project list and either directly bid on the project or contact the vendor for further information/bidding through the vendor user interface 1200R. The projects window 1210R may also show projects from other users that the vendor may bid on. A vendor database 1212R enables the vendor to store historical, as well as future predicted, pricing, inventory and project data. Business planning 1214R tools may allow vendors to plan various aspects of their business, such as determining a price elasticity of demand based on real-time market data, calculating a specific number of components to produce, setting a minimum and/or maximum on number of components to produce, and the like. There may also be links on the vendor user interface 1200R to the configuration facility, shared calendar, numerous outputs, and the like.

In embodiments, the platform 102R may include or interface with internal systems 120R. An internal system 120R may be a software, hardware or other system. In certain embodiments, the internal systems 120R may actually be external systems 122R. In an embodiment, an internal system 120R may be a sales system, which may include a sales database. The sales system may record a sale, compute the commission to the salespeople involved and interface with a payment system so that the salespeople receive the appropriate commissions. The sales system may also track sales for various salespeople and interface with a performance assessment system. In embodiments, the internal systems 120R may track and/or save all projects, configurations and proposed modular buildings, even if there is no resulting sale, and the data may be used for future sales, marketing, forecasting, design and the like.

In embodiments, the internal systems 120R may include enterprise resource planning systems, supply chain management systems, life cycle management systems, contract management systems, customer relationship management systems, accounting systems and the like. In an embodiment, the internal systems 120R may include a pricing system which may facilitate the determination of mark-ups and discounts and allow the platform to alter the prices to provide revenue to the platform provider. In another embodiment, the internal systems 120R may include a logistics system, which may determine shipping times and costs for the components, determine travel costs for individuals providing services, and optimize shipping and travel to reduce costs and shorten delivery time. In other embodiments, the internal systems 120R may be, or provide for control of, a device. The device may be a machine in a factory, a robot, an appliance, a lawn mower, a snow blower, a computer, a 3-dimensional printer and the like.

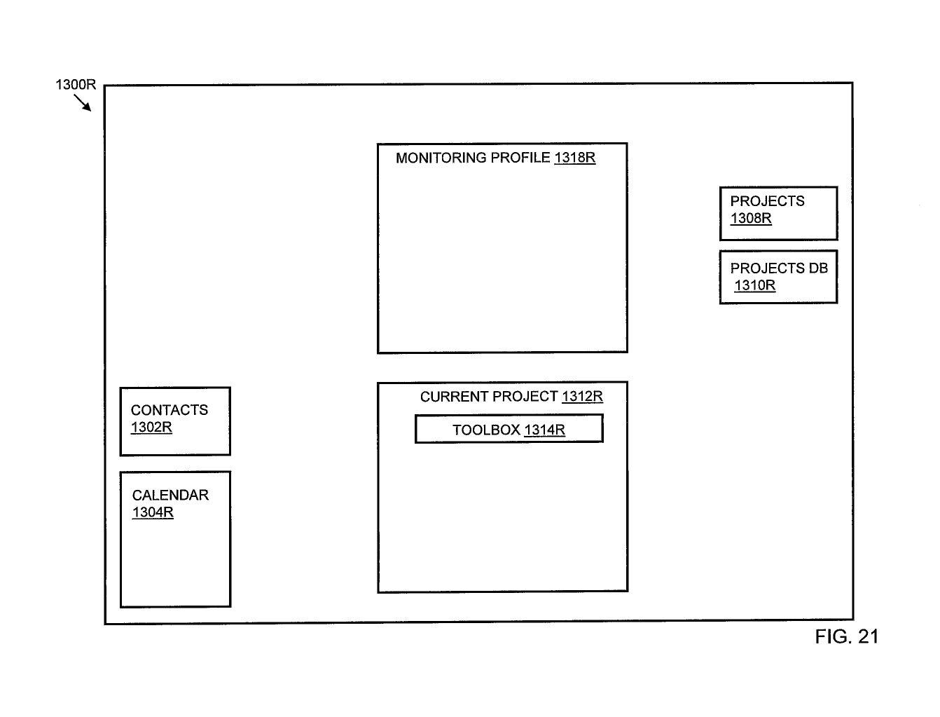

In embodiments, the internal systems 120R may include an installation monitoring facility, which may permit a user to review sensor readings, collect and aggregate data relating to an installed building or buildings and/or monitor the progress of construction of a modular building and the like. Referring to FIG. 21, the installation monitoring facility may have a user interface 1300R. A contacts 1302R window allows the user to maintain a list of contacts, such as architects, clients, vendors, fabricators, consultants, freighters, shippers, contractors, government personnel, and the like. From the window, the user may initiate contact, such as a chat, an e-mail, an audio call, a video call, a desktop share, an application share, a file share, and the like. A calendar 1304R window may allow the user to input/check availability, calculate lead times, view shared calendars of other users, set the schedule for construction and tolerances for deviations, set a schedule that considers funding, so the building can be constructed in phases with payment for each phase over time, and the like. A projects window 1308R may list all active projects and any associated lists of components, documentation, plans, and the like. A project database 1310R may list completed projects. A components window 532R may list various components and services available for including in a project and may highlight those already included in the project. The components and services may be selectable for placement in the current project window 1312R. The current project window 1312R may display the current project components and/or services shown as a list, a list with pictures, as 2-D pictures, or as 3-D representations or some combination thereof. A toolbox 1314R may enable the user to interact with the project to select a new monitored profile to display, submit the project for optimization, use the data to compare and validate the results against the predictions, simulations, optimizations and performance claims, determine the difference between the actual results and the predictions, simulations, optimizations and performance claims, submit data for a utility rebate, use the data to adjust the building and improve the performance, use the data to determine if any system or component of the building is in need of repair, use the data to determine an additional product or service that would benefit the building, and the like. A monitoring profile 1318R may enable a user to monitor the construction of a modular building.

In embodiments, the platform 102R may include or interface with external systems 122R. An internal system 120R may be a software, hardware or other system. In certain embodiments, the external systems 122R may actually be internal systems 120R. In an embodiment, an external system 122R may be a third party system. In an embodiment, an external system 122R may be a payroll system and/or a pricing system. In another embodiment, the external systems 122R may include a logistics system, which may determine shipping times and costs for the components, determine travel costs for individuals providing services, and optimize shipping and travel to reduce costs and shorten delivery time. In other embodiments, the external system 122R may be, or provide for control of, a device. The device may be a machine in a factory, a robot, an appliance, a lawn mower, a snow blower, a computer, a 3-dimensional printer and the like. The platform 102R may contain various interfaces, such as system interfaces, to other systems, internal systems, external systems, networks, the Internet, systems of the owner of the platform 102R, third party systems and the like.

In embodiments, the platform 102R may include a shared calendar 124R which may facilitate coordination, interaction and communication among the various users of the platform 102R, including without limitation, architects, vendors, fabricators, contractors and the like. The shared calendar 124R may allow users of the platform 102R to share information regarding their calendars, schedules and availability. In embodiments, the shared calendar 124R may be used to determine availability and lead times for one or more components from a particular vendor. If a vendor revises its availability in the shared calendar 124R the revision may feedback into the platform, resulting in corresponding adjustments in lead time, pricing and the like. The shared calendar 124R may be used for contract management, internal project planning, customer-facing project planning and the like. In an embodiment, the shared calendar 124R may be used to tentatively block out time in users' schedules for projects and once the project is purchased and paid for time may be officially blocked out.

In embodiments, the platform 102R may generate or be associated with various outputs 128R, including without limitation, performance predictions 130R, such as for a particular aspect or aspects of a modular building; architecture drawings 132R, such as plan drawings, elevation drawings, mechanical plans, electrical plans, foundation drawings and the like, and which may be output or exported to another system; installation drawings 134R which may describe in detail the steps for construction or assembling a modular building from the various components, and which may be output or exported to another system. The architecture drawings 132R may be delivered to the appropriate architect, such as a local architect verifying compliance with local building codes. The installation drawings 134R may be delivered to the appropriate general contractors, such as a contractor determined through a bid process completed utilizing the vendor facility 118R.

In embodiments, the outputs 128R may include a bill of materials 138R, which may specify the components, products, devices, materials, services and the like to be used in the assembly and/or construction of a modular building. For a given modular building, there may be a separate bill of materials 138R for each factory producing components and for each contractor providing components and services. The bill of materials 138R may be for an optimized building and encompasses the determined components, products, devices, materials, services and the like that will achieve the priority ranking distribution 204R for the parameters considering the pricing, availability and other data concerning the components, products, devices, materials, services and the like provided by the vendors, contractors, fabricators, suppliers and the like or determined by other means via the vendor facility 118R. The bill of materials 138R may be delivered to the appropriate general vendors, contractors, fabricators, suppliers and the like. The bill of materials 118R may be output or exported to another system.

In embodiments, the outputs 128R may include permits 140R, such as building and/or environmental permits, costing information 142R, such as cost of goods sold, quotes 144R, such as quotes for a particular component, schedules 148R, such as construction schedules, all of which may be delivered to appropriate general contractors, such as a contractor determined through a bid process completed utilizing the vendor facility.

A modular building may be customized, such as through after market customizations performed outside the platform 102R, resulting in a customization 150R. In embodiments, a customization 150R may be created or completed by an architect using the architecture drawings or a contractor in the course of constructing a modular building. A customization 150R may be a proposed customization. Customizations 150R may become the install base 152R. Customizations 150R may be provided or fed back to the platform 102R. In embodiments, the platform 102R may be used to perform simulations and optimizations in respect of a customization 150R. For example, a proposed customization 150R may be entered into the platform 102R so that permitting requirements for the customization 150R may be determined.

Various individuals, parties and entities may use or benefit from the platform 102R, including, without limitation, lay persons, architects, contractors, vendors, suppliers, fabricators, factory personnel, administrators, system administrators and the like. The platform 102R may include conditional access functionality so that different users or groups of users may have different access levels, such as for access to information, data and functionality.

The platform may contain various interfaces, including user interfaces. The user interfaces may be tailored to the various users of the platform 102R and the various functional components of the platform 102R. In embodiments, a dashboard, displaying important information and providing often-used functionality, may be provided for certain users of the platform 102R. A dashboard may vary by user.

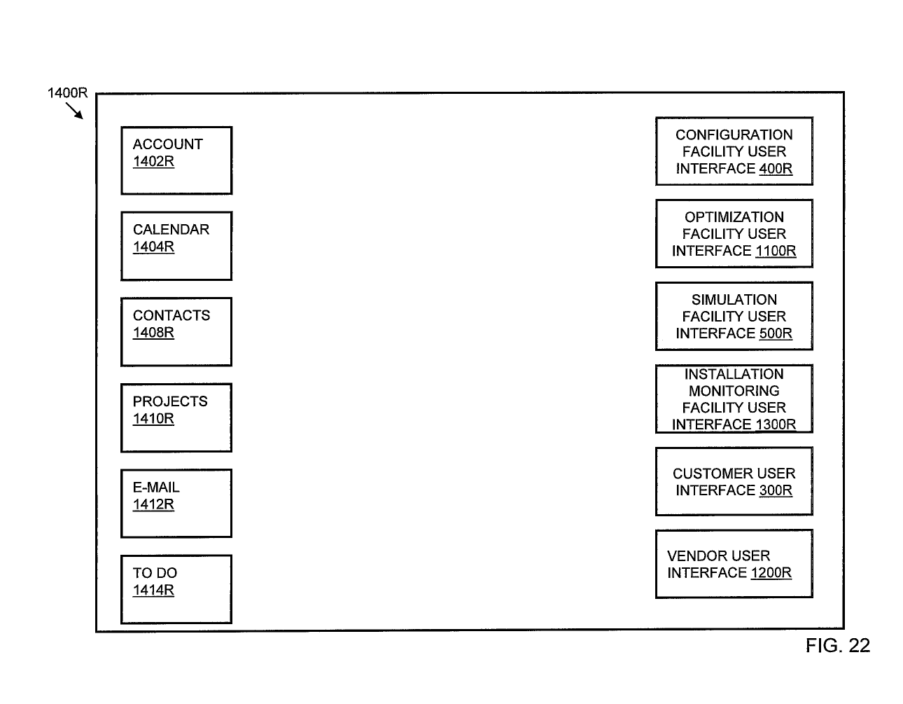

FIG. 22 depicts an architect dashboard 1400R. From the architect dashboard 1400R, the architect may be able to access his, her or its account information 1402R to make updates, manage settings, manage alerts, and the like. The architect may be able to access calendar information 1404R, such as to manage his, her or its sharing settings, manage the calendar display, manage alerts and reminders, and the like. The architect may be able to access a contacts window 1408R, such as to view and manage contacts, initiate communication with a contact, and the like. The architect may be able to access a projects window 1410R to view all active projects and any associated lists of components, documentation, plans, blueprints, drawings, and the like. The architect may be able to access his, her or its e-mail 1412R from the architect dashboard 1400R and keep a to-do list 1414R. From the architect dashboard 1400R, the architect may be able to launch the simulation facility user interface 500R, the optimization facility user interface 1100R, configuration facility user interface 400R, customer user interface 300R, installation monitoring facility user interface 1300R, vendor user interface 12008, and the like.

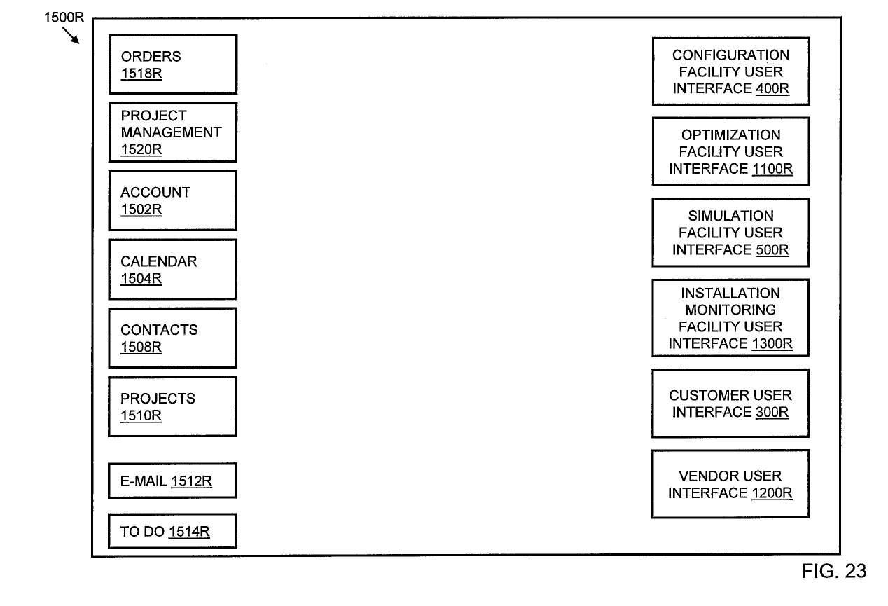

FIG. 23 depicts a contractor dashboard 1500R. From the contractor dashboard 1500R, the contractor may be able to access his, her or its account information 1502R to make updates, manage settings, manage alerts, and the like. The contractor may be able to access calendar information 1504R, such as to manage his, her or its sharing settings, manage the calendar display, manage alerts and reminders, and the like. The contractor may be able to access a contacts window 1508R, such as to view and manage contacts, initiate communication with a contact, and the like. The contractor may be able to access a projects window 1510R to view all active projects and any associated lists of components, documentation, plans, blueprints, drawings, and the like. The contractor may be able to access his, her or its e-mail 1512R from the contractor dashboard 1500R and keep a to-do list 1514R. An orders window 1518R of the contractor dashboard may allow the contractor to view, track, manage, and place new, open, pending, and completed orders. A project management window 1520R may list any components and/or services the contractor needs to order as well as a current inventory. The list may be auto-populated with components/services and quantities when a project is created, modified, or cancelled. The project management window 1520R may be used to manage labor, resources, schedules, and materials for each project, track project progress, manage contractor expenditure, manage contractor availability, and the like. The contractor may also be able to access business planning tools from the project management window 1520R. Business planning tools may allow the contractor to plan various aspects of his, her or its business, such as determining a price elasticity demand based on real-time market data, calculating a specific number of components to order, setting a minimum and/or maximum on the number of components to order, determining labor shortages or overages, and the like. From the contractor dashboard 1500R, the contractor may be able to launch the simulation facility user interface 500R, the optimization facility user interface 1100R, configuration facility user interface 400R customer user interface 300R, installation monitoring facility user interface 1300R, vendor user interface 1200R, and the like.

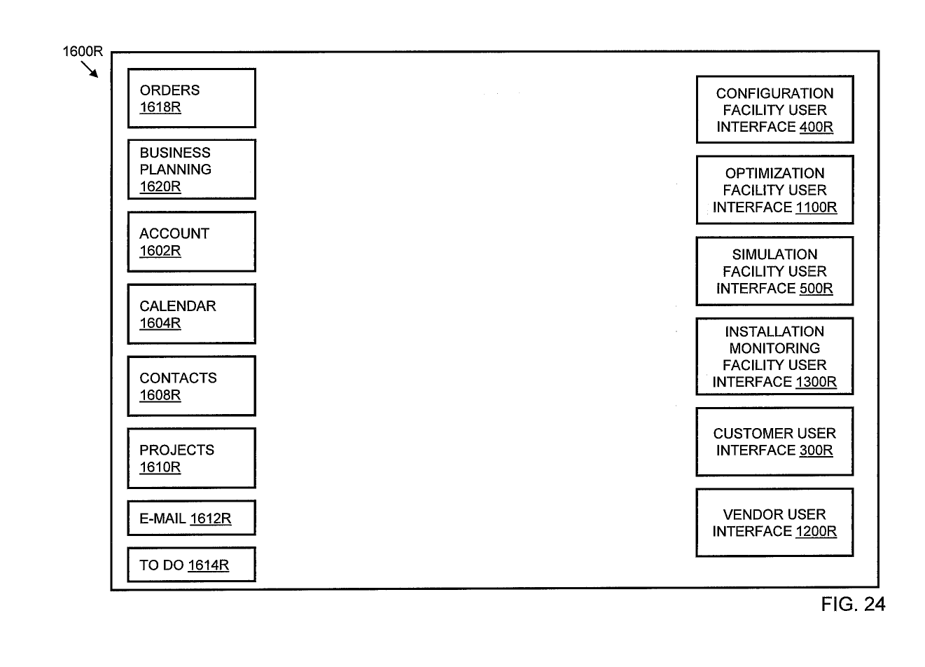

FIG. 24 depicts a vendor dashboard 1600R. From the vendor dashboard 1600R, the vendor may be able to access his, her or its account information 1602R to make updates, manage settings, manage alerts, and the like. The vendor may be able to access calendar information 1604R, such as to manage his, her or its sharing settings, manage the calendar display, manage alerts and reminders, and the like. The vendor may be able to access a contacts window 1608R, such as to view and manage contacts, initiate communication with a contact, and the like. The vendor may be able to access a projects window 1610R to view all active projects and any associated lists of components, documentation, plans, blueprints, drawings, and the like. The vendor may be able to access his, her or its e-mail 1612R from the vendor dashboard 1600R and keep a to-do list 1614R. An orders window 1618R of the vendor dashboard may allow the vendor to view, track, manage, and fulfill new, open, pending, and completed orders. A business planning tools window 1620R may list any components and/or services the vendor needs to order as well as a current inventory. The list may be auto-populated with components/services and quantities when a project is submitted to the vendor. Business planning tools may allow the vendor to plan various aspects of his, her or its business, such as determining a price elasticity demand based on real-time market data, calculating a specific number of components to produce, setting a minimum and/or maximum on number of components to produce, determining labor shortages or overages, and the like. From the vendor dashboard 1600R, the vendor may be able to launch the simulation facility user interface 500R, the optimization facility user interface 1100R, configuration facility user interface 400R, customer user interface 300R, installation monitoring facility user interface 1300R, vendor user interface 1200R, and the like.

A modular building and/or a group or network of modular buildings may be monitored. In embodiments, a modular building may comprise sensors 154R. In embodiments, sensors 154R may be located in, on, in proximity to, or otherwise associated with the modular components of the modular building or the modular building itself. Such equipped components may include, in embodiments, modular panels (which in embodiments of the invention may include, without limitation, the smart panels 20 as disclosed herein or other modular panels disclosed herein), which may facilitate monitoring of the building. In embodiments, the sensors 154R can sense and monitor various parameters, including, without limitation, climate, weather patterns, temperature, precipitation, humidity, wind, cloud cover, air quality, solar radiation, energy use, energy generation, lighting, ventilation, interior shading, exterior shading, status of glass, status of glass coatings, status of glass glazing, status of clerestory, status of store front glass, status of thermal mass, snow load, occupancy, ambient interior temperature, interior humidity, air quality, ambient light intensity, reflectivity of light, absorption of heat, operational characteristics of a component such as power usage and the like, phantom loads, power use versus need, building malfunctions such as heat leaks, plumbing leaks and the like, network state information, security related parameters, insulative properties, acoustics, sound transmission, sound reflectivity, status of and parameters relating to a living roof, status of and parameters relating to solar panels, status of and parameters relating to solar heating systems, status of and parameters relating to solar water heating systems, status of and parameters relating to biodiesel systems, status of and parameters relating to fuel cell systems, status of and parameters relating to water recycling and grey water systems, status of and parameters relating to photo-reactive materials, status of and parameters relating to wind power generation systems and the like.

In embodiments, the information provided to the platform 102R from the modular building may be direct sensor 154R data, data based on a differential between two or more sensors 154R or data processed in another manner. Other data regarding a modular buildings may be monitored and provided to the platform 102R, including, without limitation, the cost of energy, projected inflation rate, projected interest rates, projected appreciation rates, details of the location at which the modular building will be located, climate, weather patterns, temperature, precipitation, humidity, wind, cloud cover, air quality, and solar radiation, typical meteorological year data and the like. The data and information regarding the modular building, whether obtained via a sensor 154R or other means, may be used to compare and validate the results against the predictions, simulations, optimizations, performance claims and the like and may be used to determine the difference between actual results and predictions, simulations, optimizations, performance claims and the like.

In embodiments, the data from the sensors 154R may be provided to monitoring software 158R. In embodiments, the monitoring software 158R may be running in the modular building with the one or more sensors 154R providing the data, may be running in another modular building or may be housed at another location. In embodiments, the monitoring software 158R may collect, store, display, process, digest, analyze and the like the data from one or more sensors 154R. In embodiments, the monitoring software 158R may present the sensor 154R data in context, such as historical context. The monitoring software 158R may associate a sensor 154R reading with related sensor 154R readings, such as to provide contextual or historical values for a sensed parameter. The monitoring software 158R may identify and/or present trends in the sensor 154R data, as well as provide interpretations of the data and recommendations for analysis of the data. In embodiments, the monitoring software 158R may aggregate data from various sensors 154R. In embodiments, the monitoring software 158R may aggregate data from various sensors 154R related to different modular buildings. In embodiments, the monitoring software 158R may aggregate sensor 154R data across multiple modular buildings or networks of modular buildings. In embodiments, the monitoring software 158R may obtain data from, provide data to and monitor the install base of modular buildings. In embodiments, the monitoring software 158R may function as a server.

In embodiments, the data and information regarding the modular building, whether obtained via a sensor 154R or other means, may be provided to predictive performance software, such as that of the simulation facility 110R, and/or optimization software, such as that of the optimization facility 112R. In embodiments, the data and information regarding the modular building may be used to adapt and adjust the modular building, such as to improve the performance of the modular building. For example, if the climate is brighter than expected, sensors 154R in building may determine that the building is brighter inside than expected so that the lights in the building may be dimmed and a recommendation to use lower wattage lighting may be generated. In embodiments, the data and information regarding the modular building may be used to repair the building or generate recommendations or requests for repairing the building. The data and information may be used to determine if any system or component of the building is in need of repair. If a component is in need of repair or replacement, the platform 102R may generate a sales lead based on the need and repair services or replacement parts/components can be offered. In embodiments, the data and information regarding the modular building may be used to identify needs of the building or users and owners of the building. For example, the data and information regarding the modular building may be used to determine that an additional product or service would benefit the building. The platform can then generate a sales lead based on the need and the additional or replacement product or service can be offered.

The install base 152R of modular buildings can be monitored in general. The information and data from monitoring individual buildings may be aggregated, such as for a particular region. For example, the energy used by the complete install base 152R for a certain amount of time may be determined. In another embodiment, a network of modular buildings may be created and the information and data collected may be fed back into the modular building platform 102R. In yet another embodiment, the information and data from a particular modular building, including information and data collected by one or more sensors 154R, may be fed back into the modular building platform 102R. The data and information from one or more modular buildings may be used for optimizations and simulations, such as those performed by the optimization facility 112R and simulation facility 110R, respectively.

In embodiments, the platform 102R may be updated periodically or may be continuously updated in real time. The various facilities and other elements of the platform may share information and data in real time. For example, if a contractor adjusts the availability and/or price of a component, the update may be accounted for in real time in any configurations taking place using the configuration facility 108R such that the priority of the component is appropriately adjusted. In another example, if a contractor increased the lead time for a component, possibly through using the vendor facility 118R or shared calendar 124R, such that it is not available within the lead time specified by the priority ranking distribution 204R for the parameters then the component would be removed from the list of components available for use in the configuration facility 108R instantaneously after the contractor provided the updated information.

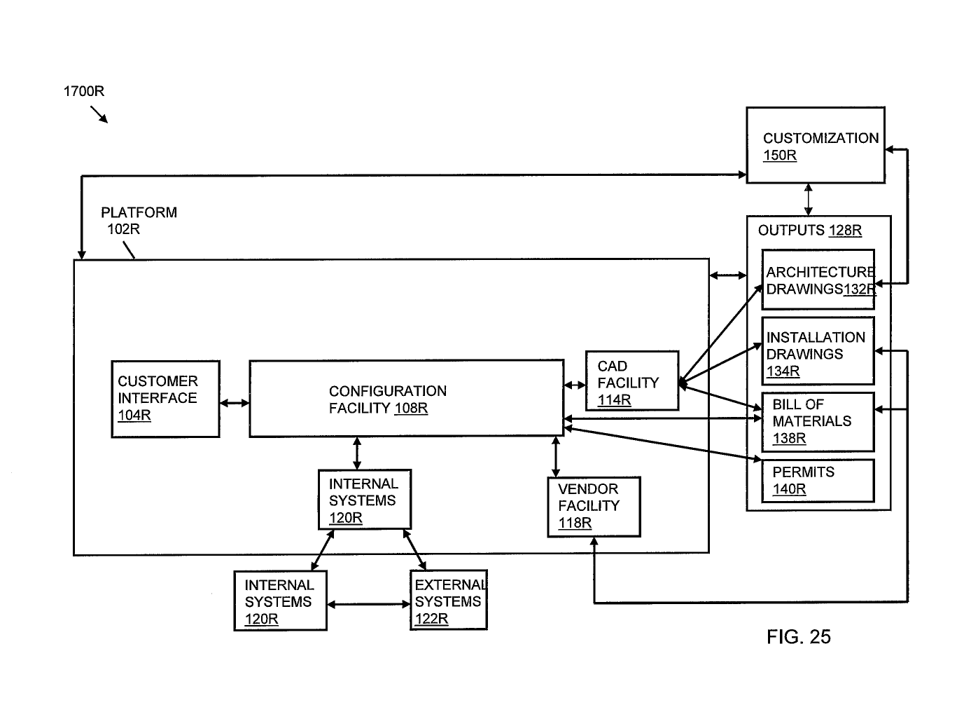

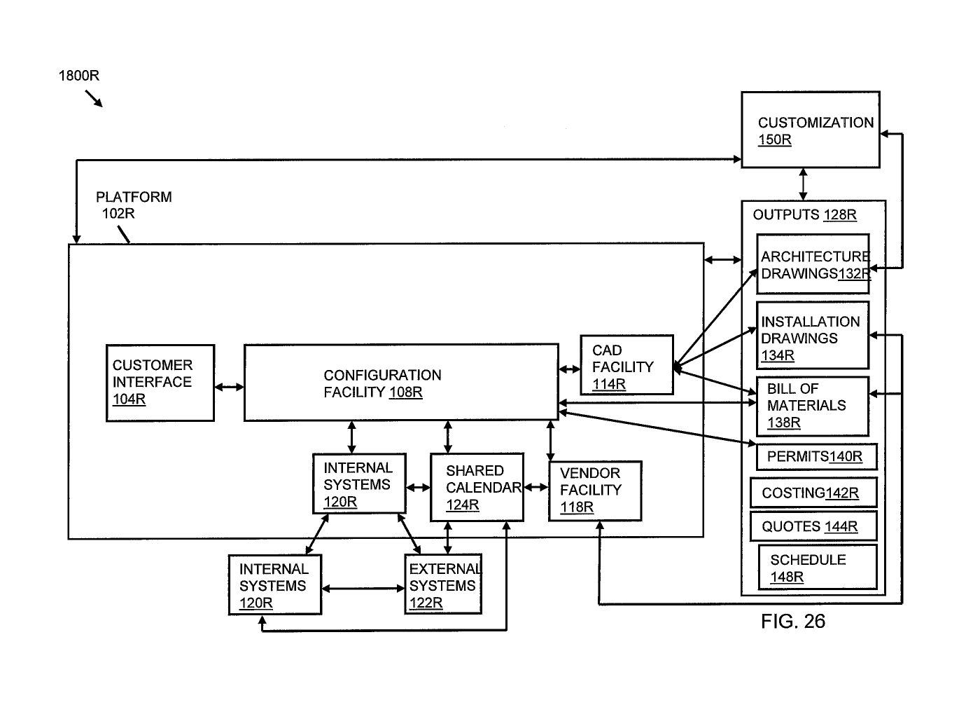

FIG. 25 depicts a pre-populated version of the platform 102R in which various models of modular buildings have been pre-selected, the simulations and optimizations run and the drawings created. Consequently, the platform 102R can provide the pre-determined information in the event a user selects one of the pre-selected models, resulting in a quicker response and less demanding processing since the calculations and other work was completed in advance. In this embodiment, the configuration facility 108R may have a pre-existing set of model modular buildings that are already optimized for different climates, resulting in a quicker response and less demanding processing. In addition, the drawings and bills of material created may have already been created for the pre-existing set of models, so no interaction with the CAD facility 114R is necessary, again resulting in a quicker response and less demanding processing. In embodiment, the pre-existing drawings may be detailed drawings which are subject to a change management process. In embodiments, the pre-existing drawings may contain abstractions which allow for sections of the drawings to be generalized. In this embodiment, the 2-dimensional drawings, such as architecture drawings 132R, may be selected from pre-existing drawings or generated through an interactive process using the platform 102R. FIG. 26 depicts a version of the pre-populated platform 102R of FIG. 25, with the addition of the shared calendar 124R which may facilitate vendor interaction.

In an embodiment, the platform 102R may be used to design, optimize and generate plans for a modular building. A user, such as a lay person or architect, may access the customer interface 104R, such as via the graphical user interface for the customer interface 300R, and specify the desired values and the tolerance for variability in those values for several configuration parameters 202R, as well as a priority ranking for the configuration parameters 202R. A priority ranking distribution 204R may then be generated. The user may then access the configuration facility 108R, such as via the graphical user interface for the configuration facility 400R, and assemble various modular components, such as smart panels 20, into a modular building. The configuration facility 108R may be used to verify that the modular components are assembled in compliance with the rules that dictate how the components may interact and be assembled. Using the CAD facility 114R, the user may generate a 3-dimensional model of the building as a preview prior to conducting any simulations or optimizations.

The user may then use the simulation facility 110R to conduct various simulations on the proposed modular building, such as via the graphical user interface for the simulation facility 500R. Using the simulation facility 110R the user may generate predictions regarding the environmental performance and cost-effectiveness of the proposed modular building, as well as model the expected lighting and temperature conditions inside the structure and the wind currents created by the building outside the structure. The user may then use the optimization facility 112R to conduct various optimizations on the proposed modular building, such as via the graphical user interface for the optimization facility 1100R. Using the optimization facility 112R the user may assess whether certain attributes of the proposed building are optimal in consideration of the priority ranking distribution 204R and the information relating to the proposed location for the building, such as weather patterns and the cost of electricity. For example, using the optimization facility 112R, the user may determine that the proposed ventilation system does not fully utilize the prevailing winds at the site and to address this issue may adjust the orientation of the building, as well as the height of the roofline. In another example, the optimization facility 112R may determine that the glazing on the windows is not optimal, since given the cost in glazing a similar reduction in the internal temperature can be achieved by including a heat dissipating foundation at lower cost than the glazing. Removing the glazing may also have the desired effect of increasing the ambient light in the module building. The user may then send the design to the CAD facility 114R, to generate a revised 3-dimensional model of the building, as well as an array of 2-dimensional drawings. The drawings may then be reviewed by a local architect to double-check compliance with the local building code.

While the user was designing, simulating and optimizing the building, and even before, various vendors were providing pricing, availability and other information for various goods and services provided on the platform 102R. The vendors may have provided aspects of this information via the vendor facility 118R, such as via the user interface for the vendor facility 1200R or the vendor dashboard 1600R. The vendors may have also provided aspects of this information via the shared calendar 124R, such as by indicating periods during which they were unavailable due to production for other modular buildings. The simulations and optimizations conducted by the user may have been based in part on the pricing, availability and other information provided by the vendors.

The user may decide to purchase the modular building, or various components and services related to the modular building. The purchase may be completed through payment systems which may compose part of the internal systems 120R. Upon payment, vendor and contractor time tentatively booked for the project in the shared calendar 124R may now be officially booked. In addition, the logistics system, which may compose part of the internal systems 120R, may schedule the shipping of the components and travel for the contractors constructing the building. An internal sales system, which may compose part of the internal systems 120R, may determine the commissions to be paid to the various salespeople involved with the transaction, and may interface with an external payroll system, such as at a payroll company, which may compose part of the external systems 122R, to request that the salespeople be paid their commissions in the next payroll cycle.

Upon purchase of the building, the platform 102R may deliver various outputs 128R. Architecture drawings 132R may be delivered to the architect, the installation drawings 134R may be delivered to the contractor constructing the building and the bill of materials 138R may be delivered to the suppliers producing the modular components. In addition, the platform 102R may automatically apply for any required permits 140R. It may be the case that in reviewing the architecture drawings 132R the architect requests a customization 150R. The customization 150R may be entered into the platform 102R and examined using the various tools of the platform 102R. For example, the optimization may be re-performed using the optimization facility 112R accounting for the customization 150R and other attributes of the building may be adjusted accordingly.

The construction of the modular building may be monitored by a user through the installation monitoring facility user interface 1300R. The building may form part of the install base of modular buildings 152R, and sensors 154R in the building may collect data and feed the data back into the platform 102R for consideration in the adjustment of this and other existing buildings, as well as the design and optimization of future buildings. It should be noted that this is only one particular embodiment. In other embodiments, the process may be performed in a different order and elements of the process may be added or omitted.

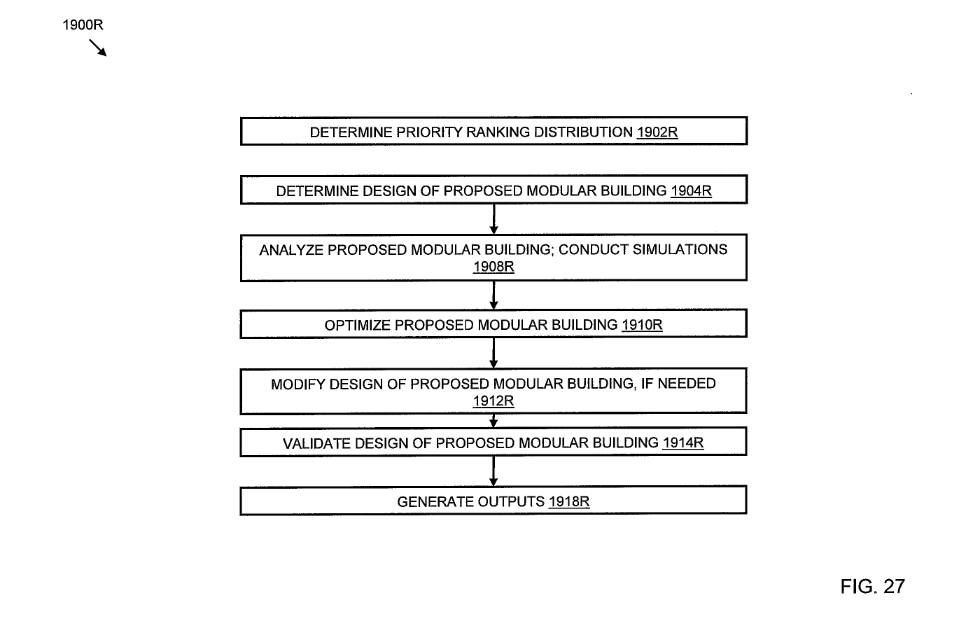

Referring to FIG. 27, in an embodiment, the processes described herein may be conducted outside the platform 102R. As a first step 1902R, the priority ranking distribution 204R may be determined by considering various parameters of interest, prioritizing all or a subset of those parameters based on importance, and specifying acceptable values or ranges of values, as well as possibly acceptable variances in those values or ranges of values, for all or a subset of those parameters. The parameters of interest may include, without limitation, quality, environmental performance, speed of delivery, cost and the like. As a second step 1904R, the design of a proposed modular building may determined. The design may be based on certain requirements, such as area, volume and aesthetics. The design may be an aggregation of various modular building components. As a third step 1908R, the design may be analyzed and various simulations may be performed. The design of the proposed modular building may be analyzed in respect of energy use, daylighting, thermal comfort and the like.

As a fourth step 1910R, the design of the modular building may be optimized. The optimization may be conducted under the constraints of the priority ranking distribution 204R. The optimization may focus on optimizing various parameters of interest, such as quality, environmental performance, speed of delivery, cost and the like, and may adjust various attributes of the design of the modular building such as materials, length of window overhangs, amount of thermal mass, inclusion of solar panels and the like. The optimization may utilize elimination parametrics, iterative techniques and the like. As a fifth step 1912R, the design of the modular building may be modified, such as based on the outcome of the optimization process. For example, the length of the window overhangs may be increased to increase shading and lower the temperature inside the building to avoid additional cooling costs. In certain embodiments, it may be the case that the optimization step 1910R or the entire process 1900R is repeated to account for the effects of any modifications.

As a sixth step 1914R, the design of the modular building may be validated. The validation may ensure that the building is safe, buildable and complies with all applicable laws, rules and regulations. It may be the case that the design of the building requires modification and these modifications may be fed back into the process, such as by starting the process over or by re-performing the optimization. As the last step 1918R, various outputs may be generated, including, without limitation, architecture drawings, installation drawings, a bill of materials and the like. It should be noted that this is only one particular embodiment. In other embodiments, the process may be performed in a different order and steps of the process may be added or omitted. In other embodiments, the process may be implemented, in whole or in part, using software, hardware, such as a computer or device, or through other means.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference in their entirety.

1. A computer-readable storage medium with an executable program stored thereon, wherein the program instructs a processor to perform the following steps:
determining a priority ranking distribution for at least two parameters to be considered in an optimization, and specifying for each parameter a desired parameter value and an importance ranking;
providing a configuration facility for generating a proposed design for a modular building;
providing a simulation facility for analyzing the proposed design in respect of selected variables;
providing an optimization facility for optimizing the proposed design under the constraints of the priority ranking distribution; and
generating outputs.

2. The computer-readable storage medium of claim 1, wherein at least a subset of the at least two parameters to be considered in the optimization are selected from the group consisting of quality, environmental performance, speed of delivery and cost.

3. The computer-readable storage medium of claim 1, wherein at least one of the specified desired parameter values is accompanied by a tolerance range.

4. The computer-readable storage medium of claim 1, wherein at least one of the specified desired parameter values is accompanied by a variance distribution.

5. The computer-readable storage medium of claim 1, wherein the proposed design of the modular building satisfies certain requirements relating to the area, volume and aesthetics of the modular building.

6. The computer-readable storage medium of claim 1, wherein the proposed modular building is composed of pre-fabricated, modular building components.

7. The computer-readable storage medium of claim 1, wherein the proposed modular building is composed of pre-fabricated, modular building components and the configuration facility is programmed with rules governing the interaction of the modular building components.

8. The computer-readable storage medium of claim 1, wherein the selected variables are selected from the group consisting of energy use, daylighting and thermal comfort.

9. The computer-readable storage medium of claim 1, wherein the optimization facility utilizes elimination parametrics at least in part.

10. The computer-readable storage medium of claim 1, wherein the outputs are selected from the group consisting of architecture drawings, installation drawings, a bill of materials, permits, quotes and schedules.

11.-17. (canceled)

18. A method, comprising:
determining a priority ranking distribution for at least two parameters to be considered in an optimization, and specifying for each parameter a desired parameter value and an importance ranking;
determining a proposed design of a modular building, wherein the proposed design satisfies certain requirements;
analyzing the proposed design in respect of selected variables;
optimizing the proposed design under the constraints of the priority ranking distribution;
modifying the proposed design based on the outcome of the optimization to create a modified proposed design;
validating the modified proposed design;
generating outputs after successful validation of the modified proposed design; and
constructing the modular building based on the output.

19. The method of claim 18, wherein at least a subset of the at least two parameters to be considered in the optimization are selected from the group consisting of quality, environmental performance, speed of delivery and cost.

20.-25. (canceled)

26. The method of claim 18, wherein the modification to the proposed design relates to a change in at least one of building materials, length of window overhangs and amount of thermal mass.

27. The method of claim 18, wherein the validation is a safety validation.

28. The method of claim 18, wherein the validation assesses compliance with laws, rules and regulations.

29. (canceled)

30. The method of claim 18, wherein the method is conducted at least in part using a particularly programmed computer processor.

31. A computer-readable storage medium with an executable program stored thereon, wherein the program instructs a processor to perform the following step:
optimizing the design of a modular building in consideration of a priority ranking distribution of parameters associated with the modular building,
wherein the priority ranking distribution ranks in terms of importance at least two of the parameters to be considered in the optimization and specifies for each parameter a desired parameter value.

32. The computer-readable storage medium of claim 31, wherein at least a subset of the at least two parameters to be considered in the optimization are selected from the group consisting of quality, environmental performance, speed of delivery and cost.

33. The computer-readable storage medium of claim 31, wherein at least one of the specified desired parameter values is accompanied by a tolerance range.

34. The computer-readable storage medium of claim 31, wherein at least one of the specified desired parameter values is accompanied by a variance distribution.
